(19) United States
(12) Patent Application Publication
(10) Pub. No.: US 2025/0030656 A1
(43) Pub. Date: Jan. 23, 2025

(54) GROUPWARE SYSTEM, DISPLAY CONTROL METHOD, AND INFORMATION STORAGE MEDIUM

(71) Applicant: Cybozu, Inc., Tokyo (JP)

(72) Inventor: Shoji YAMADA, Urayasu-shi (JP)

(21) Appl. No.: 18/776,252

(22) Filed: Jul. 18, 2024

(30) Foreign Application Priority Data
Jul. 21, 2023 (JP) 2023-119321

(51) Int. Cl. H04L 51/21

(52) U.S. Cl. CPC H04L 51/21

(57) ABSTRACT

Provided is a groupware system including at least one processor configured to: request a shared e-mail system, which manages shared e-mails, for partial data indicating a shared e-mail portion, which is a portion for the shared e-mails on a shared e-mail screen of groupware; acquire the partial data from the shared e-mail system; and display the shared e-mail screen including a groupware portion, which is a portion for the groupware, and the shared e-mail portion on a user terminal based on the partial data.

### CROSS-REFERENCE TO RELATED APPLICATION

The present disclosure contains subject matter related to that disclosed in Japanese Patent Application JP 2023-119321 filed in the Japan Patent Office on Jul. 21, 2023 the entire contents of which are hereby incorporated by reference.

### BACKGROUND OF THE INVENTION

### 1. Field of the Invention

The present disclosure relates to a groupware system, a display control method, and an information storage medium.

### 2. Description of the Related Art

Hitherto, there have been known a groupware system that provides groupware to users and a shared e-mail system that manages shared e-mails. The groupware system and the shared e-mail system have in common that both support users in tasks. Thus, when the groupware system and the shared e-mail system cooperate with each other, convenience of users is considered to be increased. For example, in U.S. Pat. No. 11,178,096, there is described a system that associates e-mails received by each user with a database in which various kinds of information available to the user are registered.

However, in related-art technologies, users are required to separately log in to groupware and a shared e-mail system and separately display the shared e-mail screen of the groupware and the shared e-mail screen of the shared e-mail system, thereby requiring time and labor of users. The system of U.S. Pat. No. 11,178,096 merely associates e-mails and a database, and cannot reduce the time and labor of users. Thus, the related-art technologies have failed to sufficiently increase convenience of users.

### SUMMARY OF THE INVENTION

One object of the present disclosure is to increase convenience of a user.

A groupware system according to at least one embodiment of the present disclosure includes at least one processor configured to: request a shared e-mail system, which manages shared e-mails, for partial data indicating a shared e-mail portion, which is a portion for the shared e-mails on a shared e-mail screen of groupware; acquire the partial data from the shared e-mail system; and display the shared e-mail screen including a groupware portion, which is a portion for the groupware, and the shared e-mail portion on a user terminal based on the partial data.

### BRIEF DESCRIPTION OF THE DRAWINGS

FIG. 1 is a diagram for illustrating an example of hardware configurations of a groupware system and a shared e-mail system.

FIG. 2 is a view for illustrating an example of a portal screen of groupware.

FIG. 3 is a view for illustrating an example of a shared e-mail screen.

FIG. 4 is a diagram for illustrating an example of functions implemented by each of the groupware system and the shared e-mail system.

FIG. 5 is a table for showing an example of an app database.

FIG. 6 is a view for illustrating an example of display data of the shared e-mail screen.

FIG. 7 is a table for showing an example of a shared e-mail database.

FIG. 8 is a flow chart for illustrating an example of processing to be executed by each of the groupware system and the shared e-mail system.

FIG. 9 is a diagram for illustrating an example of functions implemented in modification examples.

FIG. 10 is a view for illustrating an example of a link to a shared e-mail displayed in a shared e-mail portion.

FIG. 11 is a view for illustrating an example of an app setting screen.

FIG. 12 is a view for illustrating an example of a shared e-mail screen displayed on a user terminal when a user logs in to a shared e-mail service.

FIG. 13 is a view for illustrating an example of a customer management screen.

FIG. 14 is a view for illustrating an example of a project management screen.

FIG. 15 is a diagram for illustrating an example of a relationship between a template app and other apps.

### DETAILED DESCRIPTION OF THE INVENTION

### 1. Hardware Configuration of Each of Groupware System and Shared E-Mail System

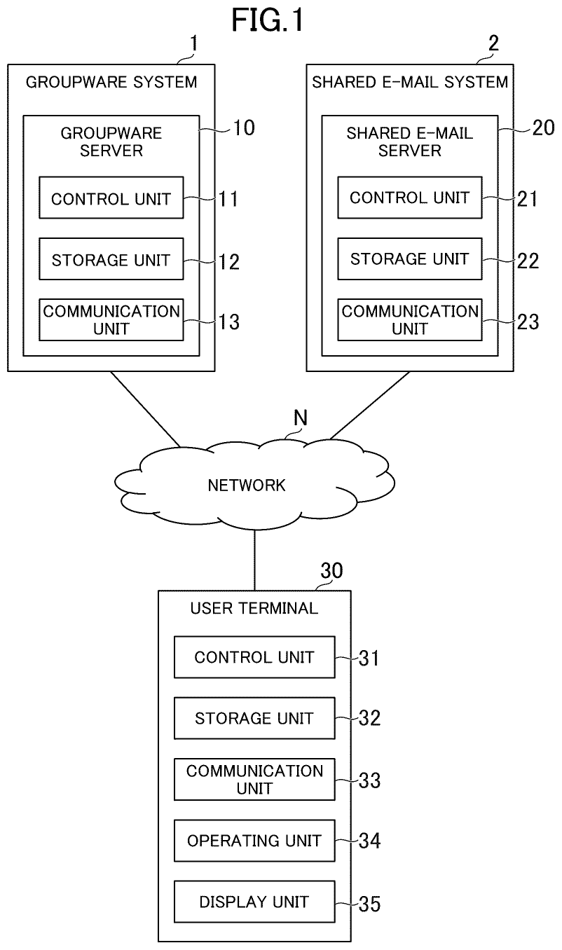

A groupware system, a shared e-mail system, a display control method, a transmission method, and a program according to at least one exemplary embodiment of the present disclosure are described below. FIG. 1 is a diagram for illustrating an example of hardware configurations of the groupware system and the shared e-mail system. For example, a groupware system 1 and a shared e-mail system 2 are each connected to a network N such as the Internet or a LAN. In the example of FIG. 1, a user terminal 30 is also connected to the network N.

The groupware system 1 is a system that provides groupware to users. The groupware is a general term for programs (software) that support users in tasks. The groupware may refer to, instead of programs, other things such as services or tools that support users in tasks. The groupware may be of any one of a cloud type or an on-premises type. The groupware may support not only organizations such as companies or government and municipal offices in tasks but also individuals in tasks.

For example, the groupware system 1 includes a groupware server 10. The groupware server 10 is a server computer. For example, the groupware server 10 includes a control unit 11, a storage unit 12, and a communication unit 13. The control unit 11 includes at least one processor. The storage unit 12 includes at least one of a volatile memory such as a RAM, or a non-volatile memory such as a flash memory. The communication unit 13 includes at least one of a communication interface for wired communication or a communication interface for wireless communication.

The computer included in the groupware system 1 is not limited to the example of FIG. 1. It suffices that the groupware system 1 includes at least one computer. For example, the groupware system 1 may include the groupware server 10 and another server computer different from the groupware server 10. The groupware system 1 may include only another computer different from the groupware server 10.

The shared e-mail system 2 is a system that manages shared e-mails. For example, the shared e-mail system 2 provides a shared e-mail service to users. The shared e-mail service is a service that transmits and receives e-mails based on an e-mail address shared by a plurality of users. The shared e-mail service can also be said to be a service that manages shared e-mails that are shared by a plurality of users. The shared e-mail can also be said to be an e-mail having an e-mail address shared by a plurality of users set in a destination, a CC, a BCC, or a sender. The shared e-mail service may be of any one of a cloud type or an on-premises type.

For example, the shared e-mail system 2 includes a shared e-mail server 20. The shared e-mail server 20 is a server computer. For example, the shared e-mail server 20 includes a control unit 21, a storage unit 22, and a communication unit 23. Hardware configurations of the control unit 21, the storage unit 22, and the communication unit 23 may be the same as those of the control unit 11, the storage unit 12, and the communication unit 13, respectively.

The computer included in the shared e-mail system 2 is not limited to the example of FIG. 1. It suffices that the shared e-mail system 2 includes at least one computer. For example, the shared e-mail system 2 may include the shared e-mail server 20 and another server computer different from the shared e-mail server 20. The shared e-mail system 2 may include only another computer different from the shared e-mail server 20.

The user terminal 30 is a computer operated by a user. For example, the user terminal 30 is a personal computer, a tablet terminal, or a smartphone. For example, the user terminal 30 includes a control unit 31, a storage unit 32, a communication unit 33, an operating unit 34, and a display unit 35. Hardware configurations of the control unit 31, the storage unit 32, and the communication unit 33 may be the same as those of the control unit 11, the storage unit 12, and the communication unit 13, respectively. The operating unit 34 is an input device, such as a mouse, a touch panel, or a keyboard. The display unit 35 is a liquid crystal display or an organic EL display.

Programs stored in at least one of the storage unit 12, the storage unit 22, or the storage unit 32 may be supplied to at least one of the groupware server 10, the shared e-mail server 20, or the user terminal 30 via the network N. Moreover, a hardware configuration of at least one of the groupware server 10, the shared e-mail server 20, or the user terminal 30 is not limited to the example of FIG. 1.

For example, at least one of the groupware server 10, the shared e-mail server 20, or the user terminal 30 includes at least one of a reading unit (for example, memory card slot) that reads an information storage medium or an input/output unit (for example, USB terminal) that is used to connect to the information storage medium. In this case, programs stored in the information storage medium may be supplied to the at least one of the groupware server 10, the shared e-mail server 20, or the user terminal 30 through the at least one of the reading unit or the input/output unit.

### 2. Outline of Each of Groupware System and Shared E-Mail System

In the at least one embodiment, a case in which a groupware provider that provides groupware to users and a shared e-mail service provider that provides a shared e-mail service to users are the same is taken as an example. For example, the same organization provides not only groupware but also a shared e-mail service to users. The groupware system 1 and the shared e-mail system 2 are independent of each other as systems, but are managed by the same organization.

The groupware provider and the shared e-mail service provider may be different from each other. For example, the groupware provider may be a first organization, and the shared e-mail service provider may be a second organization different from the first organization. In this case, the groupware system 1 and the shared e-mail system 2 are independent of each other as systems, and are managed by mutually different organizations. However, it is assumed that the groupware system 1 and the shared e-mail system 2 cooperate with each other.

In the at least one embodiment, a case in which an organization for which a user works has a contract for groupware and the user has already registered to use the groupware is taken as an example. In addition, a case in which the shared e-mail service is an optional service for groupware is taken as an example. For example, when an administrator in the organization for which the user works signs up for a shared e-mail service as a groupware option, the user becomes able to use the shared e-mail service. In the at least one embodiment, it is assumed that a series of those procedural steps has already been completed.

The shared e-mail service may be a service independent of the groupware instead of a service provided as a groupware option. In this case, the organization for which the user works makes a contract for a shared e-mail service separately from the contract for groupware. When the organization for which the user works makes a contract for a shared e-mail service, the user becomes able to use the shared e-mail service by directly logging in to the shared e-mail service. The contract for the shared e-mail service may be made before the contract for the groupware. The contract for the groupware and the contract for the shared e-mail service may be made at the same time.

In the at least one embodiment, the shared e-mail service is a service provided as a groupware option, and hence the user first logs in to the groupware in a case of using the shared e-mail service. For example, when the user selects a URL of the groupware on a browser installed on the user terminal 30, the user terminal 30 accesses the groupware server 10. When the login to the groupware is successful, the user terminal 30 displays a portal screen equivalent to an entrance to the groupware on the display unit 35.

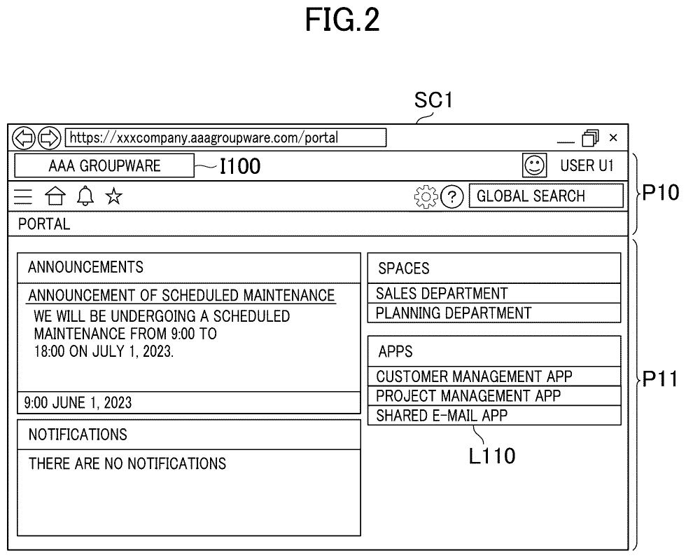

FIG. 2 is a view for illustrating an example of the portal screen of the groupware. In the example of FIG. 2, a name of the groupware is “AAA Groupware”. In a portal screen URL “https://xxxcompany.aaagroupware.com/portal”, a domain of the groupware is “xxxcompany.aaagroupware.com”. The organization of the user is xxx Company. The domain of the groupware includes a subdomain “xxxcompany” representing a name of the organization of the user.

In the at least one embodiment, each individual organization is distinctively identified by a subdomain. For example, when another organization is “yyy Company”, users of the other organization access a domain “yyycompany.aaagroupware.com” to use the groupware. However, URLs of all organizations have in common a portion “aaagroupware.com” representing the name of the groupware, and hence this portion allows users to understand that a screen being displayed is a screen within the domain of the groupware.

For example, a portal screen SC1 includes a header portion P10 corresponding to a header of the portal screen SC1 and a content portion P11 corresponding to substantial content on the portal screen SC1. The groupware server 10 can display various screens including the portal screen SC1 on the user terminal 30. The header portion P10 is generally common to most screens in the groupware. In principle, the content portion P11 differs depending on the screen displayed on the user terminal 30.

For example, a background color of the header portion P10 is a theme color of the groupware. The header portion P10 includes a groupware image I100 for showing the name of the groupware or a logo thereof. The groupware image I100 may be used as a background image of the header portion P10. The header portion P10 allows users to intuitively understand that they have logged in to the groupware. Other images such as an icon of a logged-in user and an input form for searching for content are also displayed in the header portion P10.

For example, the substantial content on the portal screen SC1 is displayed in the content portion P11 of the portal screen SC1. In the example of FIG. 2, in the content portion P11, announcements for an entire organization, individual notifications for a user, a list for showing a space for the user to communicate to/from other users, and a list L110 for showing apps available to the user are displayed.

The app is one of the tools that support users in tasks. In the at least one embodiment, a case in which the app functions as a database is taken as an example. The app may function not only as a database but also as a communication tool such as a chat or a thread. In general, the app refers to a program, but in the at least one embodiment, the app includes not only a program but also a database.

In the example of FIG. 2, three apps, namely, a customer management app, a project management app, and a shared e-mail app are displayed in the list L110. The app that can be used by each user may be any app, and is not limited to the example of FIG. 2. For example, a schedule management app, an expense reimbursement app, a report creation app, or other apps may be present in the groupware. Users may also create their own apps.

The customer management app is an app for the user to manage customers. Various kinds of customer data are stored in each record of the customer management app. For example, in each record of the customer management app, a name of a customer, a name of a person in charge, a telephone number, a FAX number, an e-mail address, a shared e-mail having the e-mail address set in a destination, a sender, or the like, and other information are stored. When the user creates a new record in the customer management app, new customer data is stored in the new record. The user can edit the customer data stored in each record of the customer management app.

The project management app is an app for the user to manage projects. The project is an individual task that is performed by the user. The project can also be said to be a piece of work. Various kinds of project data are stored in each record of the project management app. For example, in each record of the project management app, customer information on a project, a progress status of the project, a product name relating to the project, an e-mail thread relating to the project, and other information are registered. When the user creates a new record in the project management app, new project data is stored in the new record. The user can edit the project data stored in each record of the project management app.

The shared e-mail app is an app for the user to use the shared e-mail service on the groupware. In the at least one embodiment, the user can use the shared e-mail service in the same way as the user uses other apps such as the customer management app and the project management app. Any data relating to the shared e-mail may be stored in each record of the shared e-mail app. For example, in each record of the shared e-mail app, data registered in an address list of e-mail software may be stored, or data on the shared e-mail itself may be stored. For example, when the user selects the shared e-mail app from the list L110, the user terminal 30 displays, on the display unit 35, a shared e-mail screen that is a screen of the shared e-mail app.

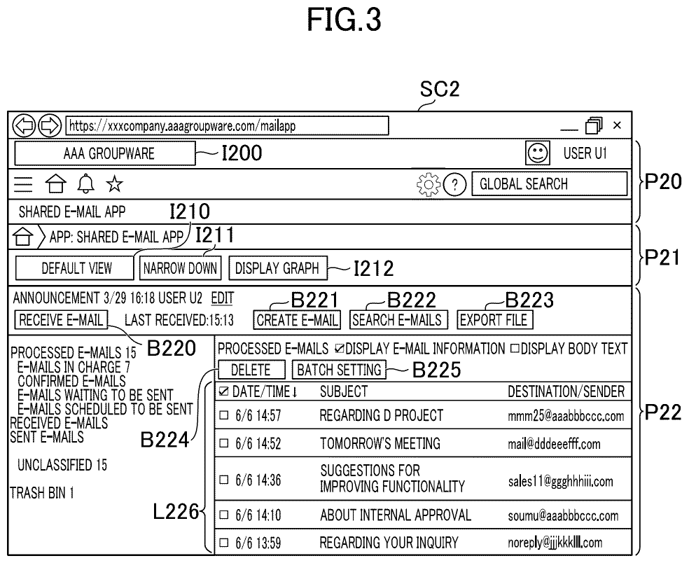

FIG. 3 is a view for illustrating an example of the shared e-mail screen. For example, a shared e-mail screen SC2 includes a header portion P20 corresponding to the header of the shared e-mail screen SC2, a content portion P21 corresponding to content of the groupware, and a shared e-mail portion P22 corresponding to content of the shared e-mail service. The header portion P20 is similar to the header portion P10. For example, the header portion P20 includes a groupware image I200, which is the same image as the groupware image I100.

For example, content of the shared e-mail app is displayed in the content portion P21 of the shared e-mail screen SC2. In the example of FIG. 3, in the content portion P21, a name of the shared e-mail app, an image 1210 for changing how to view the shared e-mail app, an image I211 for narrowing down data registered in the shared e-mail app, and an image 1212 for displaying a graph are displayed. The header portion P20 and the content portion P21 of the shared e-mail screen SC2 are generated by the groupware server 10.

For example, the content of the shared e-mail service is displayed in the shared e-mail portion P22. In the example of FIG. 3, in the shared e-mail portion P22, an image I220 for receiving a shared e-mail, an image I221 for creating a new shared e-mail, an image 1222 for searching shared e-mails, an image I223 for exporting a file of a shared e-mail, an image I224 for deleting a shared e-mail, an image 1225 for a batch setting of shared e-mails, and a list L226 of the shared e-mails are displayed. The shared e-mail portion P22 of the shared e-mail screen SC2 is generated by the shared e-mail server 20.

In the at least one embodiment, when the user selects the shared e-mail app from the list L110 on the portal screen SC1, the groupware server 10 requests the shared e-mail server 20 to generate partial data indicating the shared e-mail portion P22. In the at least one embodiment, a case in which the user uses a browser is taken as an example, and hence the partial data is HTML data (HTML format file). Details of the partial data are described later.

For example, when the shared e-mail server 20 receives a request from the groupware server 10, the shared e-mail server 20 identifies the shared e-mails of the user to generate partial data. The shared e-mail server 20 transmits the partial data to the groupware server 10. The groupware server 10 receives the partial data from the shared e-mail server 20. The groupware server 10 displays, on the user terminal 30, the shared e-mail screen SC2 including the header portion P20 and the content portion P21 that have been generated by the groupware server 10 itself and the shared e-mail portion P22 indicated by the partial data.

In the at least one embodiment, the groupware server 10 uses an inline frame (iframe), which is one of HTML elements, to embed, in the shared e-mail screen SC2, the shared e-mail portion P22 indicated by the partial data received from the shared e-mail server 20. Thus, the user can view the shared e-mails while staying logged in to the groupware without logging in to the shared e-mail service. Details of the groupware system 1 and the shared e-mail system 2 are described below.

### 3. Functions Implemented by Each of Groupware System and Shared E-Mail System

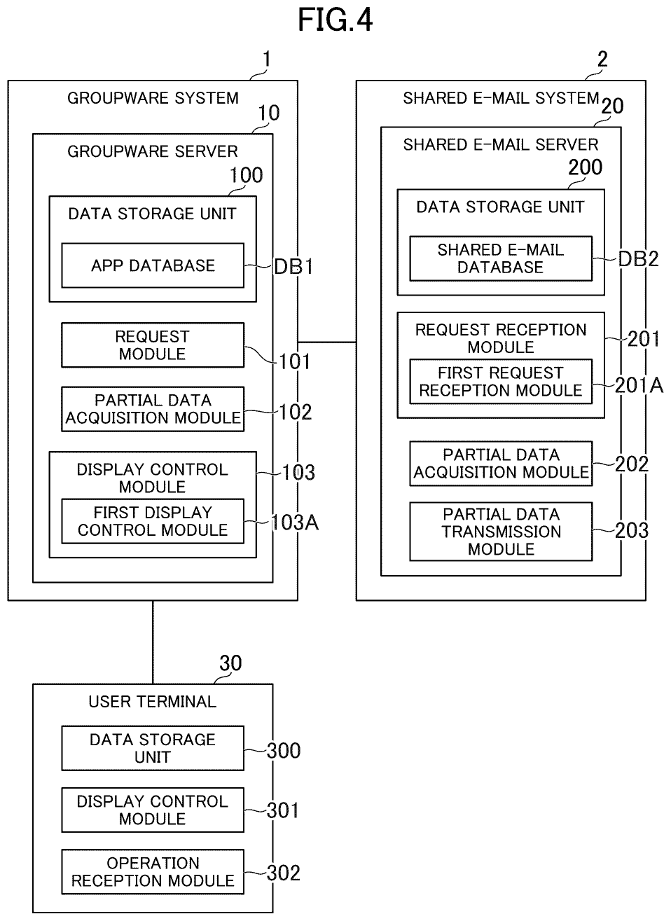

FIG. 4 is a diagram for illustrating an example of functions implemented by each of the groupware system 1 and the shared e-mail system 2. In FIG. 4, functions implemented by the user terminal 30 are also illustrated.

### 3-1. Functions Implemented by Groupware System

For example, in the groupware system 1, the groupware server 10 includes a data storage unit 100, a request module 101, a partial data acquisition module 102, and a display control module 103. The data storage unit 100 is implemented by the storage unit 12. Each of the request module 101, the partial data acquisition module 102, and the display control module 103 is implemented by the control unit 11.

### [Data Storage Unit]

The data storage unit 100 stores data required for the user to use the groupware. For example, the data storage unit 100 stores an app database DB1 in which various kinds of data on each app are stored.

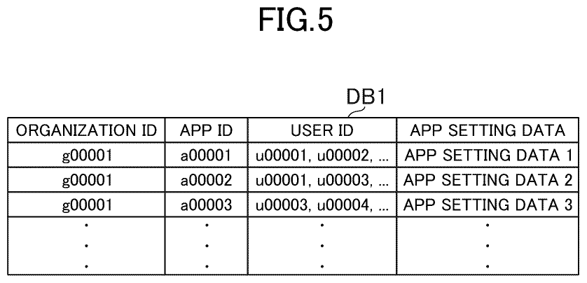

FIG. 5 is a table for showing an example of the app database DB1. For example, the app database DB1 stores an organization ID for the groupware server 10 to identify an organization of a user, an app ID for the groupware server 10 to identify an app, a user ID for the groupware server 10 to identify the user, and app setting data indicating settings of the app. The app database DB1 may store any data, and the data stored in the app database DB1 is not limited to the example of FIG. 5. For example, the app database DB1 may store record data indicating records of apps.

For example, the app setting data indicates a name of an app, a name of a field, an access right, and other settings. The app setting data is only required to indicate settings corresponding to the app, and may include any information. When an administrator of a certain organization performs an operation to add an app, the groupware server 10 creates a new record in the app database DB1. The groupware server 10 stores, in the new record, the app ID of the app added by the administrator, the user ID of a user who can use the app, and the app setting data indicating settings designated by the administrator.

The administrator can add any app prepared in the groupware to his or her own organization. The administrator may create an app by himself or herself. The app database DB1 may store data indicating the app created by the administrator. The app may be prepared from the beginning instead of being added by an operation of the administrator. The app may be a default function of the groupware instead of being an optional function of the groupware.

In the at least one embodiment, the shared e-mail app is mainly described. For example, the app setting data on the shared e-mail app indicates an e-mail address that is shared by the shared e-mail app. For example, the e-mail address is a representative address of the organization for which the user works. In the shared e-mail app, a plurality of e-mail addresses may be shared. The groupware server 10 is required to inform the shared e-mail server 20 of an e-mail address on which partial data is requested to be generated. The app database DB1 stores e-mail address identification data for the shared e-mail server 20 to identify the e-mail address.

The e-mail address identification data may be the e-mail address itself, but in the at least one embodiment, is assumed to be an organization ID. For example, the groupware server 10 transmits the organization ID to the shared e-mail server 20 as the e-mail address identification data. The shared e-mail server 20 manages in advance which organization uses which e-mail address, and can identify the e-mail address on which partial data is to be generated based on the organization ID received from the groupware server 10.

The e-mail address identification data may be other data different from the organization ID and the e-mail address. For example, the e-mail address identification data may be the app ID, the user ID in the groupware, a user ID in the shared e-mail service, or some other information equivalent to an account. The user ID in the groupware and the user ID in the shared e-mail service may be different from each other or may be the same.

Further, the data stored in the data storage unit 100 is not limited to the app database DB1. The data storage unit 100 may store any data. For example, the data storage unit 100 may store a user database in which various kinds of data on each user in the groupware are stored. The user database stores an organization ID, a user ID, and a password. For example, the data storage unit 100 may store HTML data of the portal screen SC1, the shared e-mail screen SC2, and other screens or parts thereof, image data of individual images to be displayed on those screens, and the partial data acquired by the partial data acquisition module 102.

### [Request Module]

The request module 101 requests the shared e-mail system 2, which manages shared e-mails, for partial data indicating the shared e-mail portion P22, which is a portion for the shared e-mails on the shared e-mail screen SC2 of the groupware. When the user uses a browser, a screen for the shared e-mails that is displayed under the domain of the groupware corresponds to the shared e-mail screen SC2 of the groupware. When a program (for example, so-called smartphone app) dedicated to the groupware is used, a screen for the shared e-mails that is displayed on the program corresponds to the shared e-mail screen SC2 of the groupware.

The shared e-mail portion P22 is a portion (area) of the shared e-mail screen SC2 in which shared e-mails are displayed. The shared e-mail portion P22 may be any portion in which some information on the shared e-mails is displayed. For example, in the shared e-mail portion P22, body text of the shared e-mails may be displayed, or only subjects of the shared e-mails may be displayed instead of the body text of the shared e-mails. In the shared e-mail portion P22, the subjects of the shared e-mails, a list of the shared e-mails, links to the shared e-mails, destinations of the shared e-mails, CCs of the shared e-mails, BCCs of the shared e-mails, senders of the shared e-mails, or other information may be displayed.

In the at least one embodiment, a case in which the partial data is HTML data is taken as an example. The partial data may have any format, and is not limited to HTML data. Examples of the partial data may include data in a markup language (for example, XML, SGML, or XHTML) other than HTML, data (for example, EML format data) representing each shared e-mail itself, image data such as JPEG or GIF image data, text data representing details of each shared e-mail, a link (relative path or absolute path) to the data of the shared e-mail portion P22, and data having another format.

For example, the request module 101 transmits data indicating that the request is for partial data to the shared e-mail system 2, to thereby request the partial data from the shared e-mail system 2. For example, the data has a format defined by an API of the shared e-mail system 2. The request module 101 transmits the e-mail address identification data (organization ID in the at least one embodiment) to the shared e-mail system 2, to thereby request the partial data therefrom. The shared e-mail system 2 can identify, based on the e-mail address identification data received from the groupware system 1, the e-mail address of which the partial data on the shared e-mails is to be generated.

### [Partial Data Acquisition Module]

The partial data acquisition module 102 acquires the partial data from the shared e-mail system 2. For example, the partial data acquisition module 102 acquires, from the shared e-mail system 2, the partial data transmitted by a partial data transmission module 203 described later. The acquisition as used herein refers to reception. The partial data acquisition module 102 records the partial data acquired from the shared e-mail system 2 in the data storage unit 100.

### [Display Control Module]

The display control module 103 displays, on the user terminal 30, various screens of the groupware. The screen of the groupware is a screen that is displayed based on data generated by the groupware server 10. As in the at least one embodiment, when the user uses a browser, a screen (web page or website) belonging to the domain of the groupware is a screen of the groupware. When the user uses a program (for example, so-called smartphone app) dedicated to the groupware, the screen on the program is the screen of the groupware. The display control module 103 transmits display data of a screen to be displayed to the user terminal 30, to thereby display the screen on the user terminal 30.

The display data may be any data that is required for displaying a screen, and may have any format. As in the at least one embodiment, when a browser is used, the display data has an HTML format. The display data may be data in a markup language (for example, XML, SGML, or XHTML) other than HTML or data having another format. When the user uses a program (for example, so-called smartphone app) dedicated to the groupware, it suffices that data (for example, image data such as JPEG or GIF image data) required for the program to display some screen corresponds to the display data.

For example, the display control module 103 includes a first display control module 103A. The first display control module 103A is a function for displaying the shared e-mail screen SC2 among functions of the display control module 103. The first display control module 103A displays, on the user terminal 30, the shared e-mail screen SC2 including a groupware portion, which is a portion for the groupware, and the shared e-mail portion P22 based on the partial data. The first display control module 103A transmits the display data of the shared e-mail screen SC2 to the user terminal 30, to thereby display the shared e-mail screen SC2 on the user terminal 30.

The groupware portion is a portion (area) of the shared e-mail screen SC2 in which information on the groupware side is displayed. In the example of FIG. 3, the header portion P20 and the content portion P21 correspond to the groupware portion. Thus, the “header portion P20” and “content portion P21” as used herein can be read as “groupware portion.” The groupware portion may be any portion in which some information on the groupware side is displayed, and is not limited to the header portion P20 and the content portion P21. For example, the groupware portion may be a portion corresponding to a footer or a menu of the groupware.

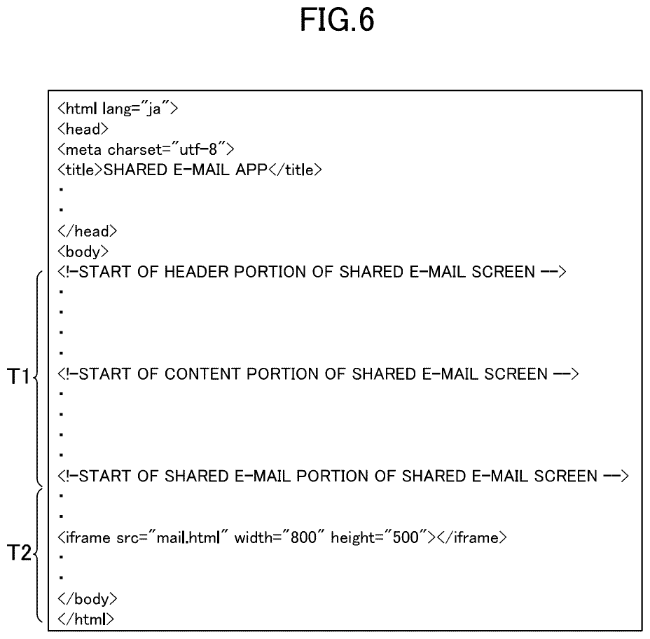

FIG. 6 is a view for illustrating an example of the display data of the shared e-mail screen SC2. In the example of FIG. 6, only a part of the display data of the shared e-mail screen SC2 is illustrated. For example, the first display control module 103A generates display data including an HTML tag T1 indicating the groupware portion and an HTML tag T2 indicating the shared e-mail portion P22. The HTML tag T1 indicating the groupware portion may be the same as an HTML tag employed in publicly-known groupware. Thus, description of the HTML tag T1 within the display data is omitted. The first display control module 103A generates the HTML tag T1 by the same method as a method of publicly-known groupware.

In the at least one embodiment, the HTML tag T2 indicating the shared e-mail portion P22 is an inline frame. In the example of FIG. 6, the HTML tag T2 includes an inline frame tag such as ‘<iframe src=“mail.html” width=“800” height=“500”></iframe>’. The value “mail.html” is a relative path indicating a location of the partial data. In the example of FIG. 6, the partial data is on the same hierarchical level as that of the display data, and hence the value “mail.html”, which is a file name of the partial data, is designated as a relative path. The partial data may be designated by an absolute path instead of a relative path. When the partial data is designated by an absolute path, the absolute path may include the domain of the groupware, or may include a domain of the shared e-mail service or another service.

For example, the shared e-mail portion P22 is inserted into a portion of the shared e-mail screen SC2 in which the inline frame tag in the display data is designated. In the example of FIG. 6, a width and a height of the shared e-mail portion P22 are designated. However, the width and the height of the shared e-mail portion P22 are not required to be particularly designated. The HTML tag T2 may include another tag different from the inline frame tag. For example, the HTML tag T2 may include a tag indicating some script.

For example, the first display control module 103A generates an HTML tag T2 based on the file name of the partial data acquired by the partial data acquisition module 102. The first display control module 103A may change the file name of the partial data designated by the shared e-mail system 2 and generate the HTML tag T2 based on the changed file name. When an administrator of the shared e-mail app designates a size of the shared e-mail portion P22, the first display control module 103A may generate the HTML tag T2 based on the designated size. The first display control module 103A generates display data including the HTML tag T1 and the HTML tag T2, and transmits the display data to the user terminal 30.

The first display control module 103A may display the shared e-mail screen SC2 including the shared e-mail portion P22 on the user terminal 30 without the use of an inline frame. For example, instead of using such an inline frame tag as illustrated in FIG. 6, the first display control module 103A may embed an HTML tag indicated by the partial data in the display data as a body portion (portion between “<body>” and “</body>”) of the display data. For example, instead of using such an inline frame tag as illustrated in FIG. 6, the first display control module 103A may embed a link to the partial data in the display data.

### 3-2. Functions Implemented by Shared E-Mail System

For example, in the shared e-mail system 2, the shared e-mail server 20 includes a data storage unit 200, a request reception module 201, a partial data acquisition module 202, and the partial data transmission module 203. The data storage unit 200 is implemented by the storage unit 22. The request reception module 201, the partial data acquisition module 202, and the partial data transmission module 203 are implemented by the control unit 21.

### [Data Storage Unit]

The data storage unit 200 stores data required for the user to use the shared e-mail service. For example, the data storage unit 200 stores a shared e-mail database DB2 in which various kinds of data on each shared e-mail are stored.

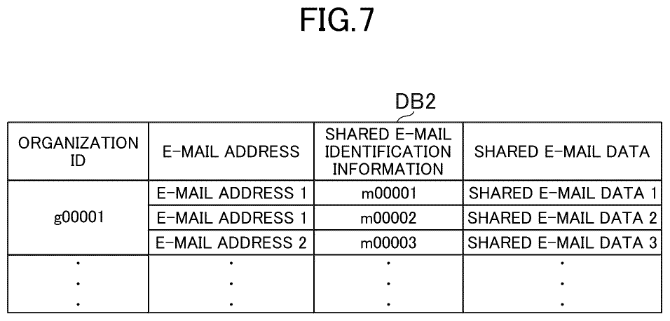

FIG. 7 is a table for showing an example of the shared e-mail database DB2. For example, the shared e-mail database DB2 stores an organization ID, an e-mail address shared within the organization, shared e-mail identification information for the shared e-mail server 20 to identify a shared e-mail, and shared e-mail data indicating the shared e-mail. The shared e-mail database DB2 may store any data, and the data stored in the shared e-mail database DB2 is not limited to the example of FIG. 7. For example, data indicating folders into which shared e-mails are sorted may be stored in the shared e-mail database DB2.

For example, the shared e-mail server 20 issues shared e-mail identification information on a certain shared e-mail so that the shared e-mail identification information does not overlap with shared e-mail identification information on another shared e-mail. The shared e-mail identification information may have any format, for example, numbers, letters, other symbols, or a combination thereof. The shared e-mail identification information may be information employed in a publicly-known shared e-mail service. Each time a shared e-mail is received to the e-mail address of a certain organization, the shared e-mail server 20 issues the shared e-mail identification information on the shared e-mail. The shared e-mail server 20 stores the organization ID, the e-mail the address, shared e-mail identification information, and the shared e-mail data of the shared e-mail in the shared e-mail database DB2 in association with each other. Instead of being issued by the shared e-mail server 20, the shared e-mail identification information may be a message ID included in a header of the shared e-mail.

For example, the shared e-mail data indicates at least one of a date and time at which a shared e-mail was received, the sender of the shared e-mail, the destination of the shared e-mail, the CC of the shared e-mail, the BCC of the shared e-mail, the subject of the shared e-mail, the body text of the shared e-mail, the attached file of the shared e-mail, an e-mail thread of the shared e-mail, a comment written for the shared e-mail, or a flag given to the shared e-mail. The shared e-mail data may be data employed in a publicly-known shared e-mail service. The shared e-mail data indicates substantial content on the shared e-mail screen SC2 in the shared e-mail portion P22 thereof.

The data stored in the data storage unit 200 is not limited to the shared e-mail database DB2. The data storage unit 200 may store any data. For example, when the user directly logs in to the shared e-mail service, the data storage unit 200 may store a user database in which various kinds of data on each user in the shared e-mail service are stored. The user database stores an organization ID, a user ID, and a password. For example, the data storage unit 200 may store HTML data of screens to be displayed when the user directly logs in to the shared e-mail service or parts thereof and image data of individual images to be displayed on those screens.

### [Request Reception Module]

The request reception module 201 receives various requests from at least one of the groupware system 1 or the user terminal 30. In the at least one embodiment, it is assumed that the user does not directly log in to the shared e-mail service. Thus, it is assumed that the request reception module 201 does not receive a request from the user terminal 30 but receives a request from the groupware system 1. The request received by the request reception module 201 is data having a format defined by the API of the shared e-mail system 2.

For example, the request reception module 201 includes a first request reception module 201A. The first request reception module 201A is a function for receiving a request for partial data among functions of the request reception module 201. The first request reception module 201A receives the request for the partial data indicating the shared e-mail portion P22, which is the portion for the shared e-mails on the shared e-mail screen of the groupware, from the groupware system 1 that provides the groupware to users. In the at least one embodiment, the first request reception module 201A receives the e-mail address identification data (organization ID in the at least one embodiment) from the groupware system 1, to thereby receive the request for the partial data.

### [Partial Data Acquisition Module]

The partial data acquisition module 202 acquires partial data when the first request reception module 201A receives a request. The partial data may be stored in advance in the data storage unit 200, but in the at least one embodiment, the partial data acquisition module 202 generates partial data based on the request received by the request reception module 201. That is, in the at least one embodiment, it is assumed that the partial data is not prepared in advance before the request reception module 201 receives the request but is dynamically generated on the spot after the request reception module 201 receives the request.

In the at least one embodiment, the partial data is the HTML data of the shared e-mail portion P22. In the example of FIG. 6, the partial data is data having a file name of “mail.html”. For example, the partial data acquisition module 202 identifies the shared e-mails that are to be included in the shared e-mail portion P22 based on the request received by the first request reception module 201A and the shared e-mail database DB2. The partial data acquisition module 202 acquires the shared e-mails from the shared e-mail database DB2 based on the e-mail address identification data included in the request received by the first request reception module 201A.

In the at least one embodiment, the organization ID corresponds to the e-mail address identification data, and hence the partial data acquisition module 202 acquires all or a part of the shared e-mail data associated with the organization ID from the shared e-mail database DB2. For example, the partial data acquisition module 202 identifies, from the shared e-mail database DB2, the shared e-mails in which the e-mail address associated with the organization ID is set in the sender, destination, the CC, or the BCC.

For example, the partial data acquisition module 202 generates data of the list L226 in which the subjects of the shared e-mails are arranged. The list L226 is assumed to include links to the individual shared e-mails. For example, the link includes the shared e-mail identification information. The partial data acquisition module 202 reads out the image data of buttons B220 to B225 stored in the data storage unit 200, and generates, as the partial data, HTML data including the buttons B220 to B225 and the list L226.

The partial data acquisition module 202 may generate partial data having the same format as that of HTML data of a screen in a publicly-known shared e-mail service. A method of generating partial data in this case may be the same as a method of generating HTML data of a screen in a publicly-known shared e-mail service. It is assumed that data required for the partial data acquisition module 202 to acquire the partial data is stored in advance in the data storage unit 200.

### [Partial Data Transmission Module]

The partial data transmission module 203 transmits the partial data to the groupware system 1. For example, the partial data transmission module 203 transmits the partial data acquired by the partial data acquisition module 202 to the groupware system 1. The partial data transmission module 203 may transmit other data such as the file name of the partial data to the groupware system 1.

### 3-3. Functions Implemented by User Terminal

For example, the user terminal 30 includes a data storage unit 300, a display control module 301, and an operation reception module 302. The data storage unit 300 is implemented by the storage unit 32. The display control module 301 and the operation reception module 302 are implemented by the control unit 31.

### [Data Storage Unit]

The data storage unit 300 stores data required for the user to use at least one of the groupware or the shared e-mail service. For example, the data storage unit 300 stores a browser. For example, the data storage unit 300 stores a program dedicated to the groupware. The data storage unit 300 may store a program dedicated to the shared e-mail service.

### [Display Control Module]

The display control module 301 displays, on the display unit 35, each screen of the groupware. In the at least one embodiment, a case in which the display control module 301 displays each screen on a browser is taken as an example, but the display control module 301 may also display each screen on a program dedicated to the groupware. When the user directly logs in to the shared e-mail service, the display control module 301 may display each screen on a program dedicated to the shared e-mail service.

### [Operation Reception Module]

The operation reception module 302 receives an operation performed on each screen displayed on the display unit 35 by the display control module 301. The operation reception module 302 transmits operation data indicating the operation performed by the user to the groupware server 10. When the user directly logs in to the shared e-mail service, the operation reception module 302 receives an operation performed on the screen of the shared e-mail service.

### 4. Processing to be Executed by Each of Groupware System and Shared E-Mail System

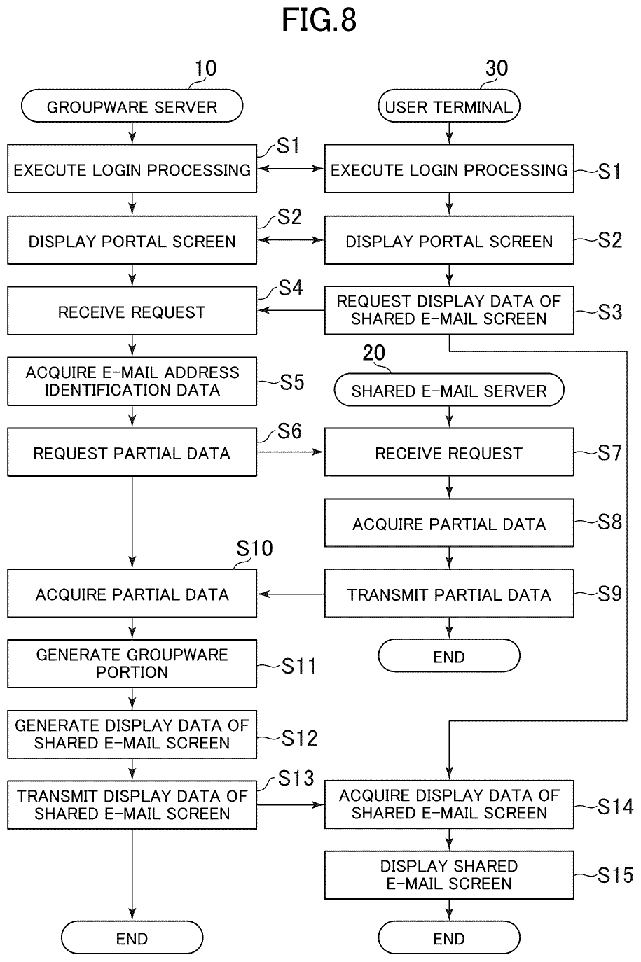

FIG. 8 is a flow chart for illustrating an example of processing to be executed by each of the groupware system 1 and the shared e-mail system 2. In FIG. 8, processing to be executed by the user terminal 30 is also illustrated. The processing of FIG. 8 is executed by the control units 11, 21, and 31 executing programs stored in the storage units 12, 22, and 32, respectively. In FIG. 8, processing for displaying the shared e-mail screen SC2 is mainly illustrated.

As illustrated in FIG. 8, when the user selects the URL of the groupware from the browser of the user terminal 30, the user terminal 30 cooperates with the groupware server 10 to execute login processing for the user to log in to the groupware (Step S1). When the login is successful, the groupware server 10 and the user terminal 30 cooperate with each other to execute processing for displaying the portal screen SC1 (Step S2). In Step S2, the groupware server 10 transmits the display data of the portal screen SC1 to the user terminal 30. The user terminal 30 receives the display data of the portal screen SC1 and displays the portal screen SC1 on the display unit 35.

When the user selects the shared e-mail app from the list L110, the user terminal 30 requests the groupware server 10 for the display data of the shared e-mail screen SC2 (Step S3). The groupware server 10 receives the request for the display data of the shared e-mail screen SC2 from the user terminal 30 (Step S4). The groupware server 10 acquires the e-mail address identification data based on the app database DB1 (Step S5). The groupware server 10 requests the shared e-mail server 20 for the partial data based on the e-mail address identification data identified in Step S5 (Step S6).

The shared e-mail server 20 receives the request for the partial data from the groupware server 10 (Step S7). The shared e-mail server 20 acquires the partial data based on the e-mail address identification data included in the request received in Step S7 and the shared e-mail database DB2 (Step S8). In Step S8, the shared e-mail server 20 acquires the shared e-mail in the shared e-mail database DB2 based on the e-mail address identification data identified in Step S8. The shared e-mail server 20 arranges the subjects of the acquired shared e-mails in the list L226 in order of the date and time of the reception. The shared e-mail server 20 arranges the buttons B220 to B225 at predetermined positions based on the image data stored in the storage unit 22. The shared e-mail server 20 generates partial data indicating the shared e-mail portion P22 including the buttons B220 to B225 and the list L226.

The shared e-mail server 20 transmits the partial data acquired in Step S8 to the groupware server 10 (Step S9). The groupware server 10 acquires the partial data from the shared e-mail server 20 (Step S10). The groupware server 10 generates a groupware portion (for example, header portion P20 and content portion P21) based on the user database and the image data stored in the storage unit 12 (Step S11). The processing step of Step S11 may be executed before the processing step of Step S10.

The groupware server 10 generates display data of the shared e-mail screen SC2 including the header portion P20 and content portion P21 generated in Step S11 and the shared e-mail portion P22 indicated by the partial data acquired in Step S10 (Step S12). In Step S12, the groupware server 10 generates display data including the HTML tag T1 indicating the header portion P20 and content portion P21 generated in Step S11 and the HTML tag T2 in which the partial data acquired in Step S10 is designated through use of an inline frame.

The groupware server 10 transmits the display data of the shared e-mail screen SC2 to the user terminal 30 (Step S13). The user terminal 30 acquires the display data of the shared e-mail screen SC2 from the groupware server 10 (Step S14). The user terminal 30 displays the shared e-mail screen SC2 on the display unit 35 based on the display data acquired in Step S14 (Step S15), and this process is ended.

### 5. Summary of at Least One Embodiment

The groupware system 1 according to the at least one embodiment requests the shared e-mail system 2 for the partial data. The groupware system 1 acquires the partial data from the shared e-mail system 2. The groupware system 1 displays a shared e-mail screen SC2 on the user terminal 30 based on the partial data. The groupware system 1 allows the user to view the shared e-mails on the screen of the groupware while staying logged in to the groupware, thereby being able to increase convenience of the user. For example, instead of using both the groupware and the shared e-mail service, the user can use the shared e-mail service as well while the user seemingly uses only the groupware. The groupware system 1 can substantially integrate the shared e-mail service into the groupware.

The shared e-mail system 2 in the at least one embodiment receives the request for the partial data from the groupware system 1. When the shared e-mail system 2 receives the request, the shared e-mail system 2 acquires partial data. The shared e-mail system 2 transmits the partial data to the groupware system 1. The shared e-mail system 2 can provide the groupware system 1 with the partial data required for the groupware system 1 to display, on the user terminal 30, the shared e-mail screen SC2 that increases the convenience of the user. As a result, the user can view the shared e-mails on the screen of the groupware while staying logged in to the groupware, and hence the shared e-mail system 2 can increase the convenience of the user.

### 6. Modification Examples

The present disclosure is not limited to the example of the at least one embodiment. The present disclosure can be modified without departing from the purport of the present disclosure.

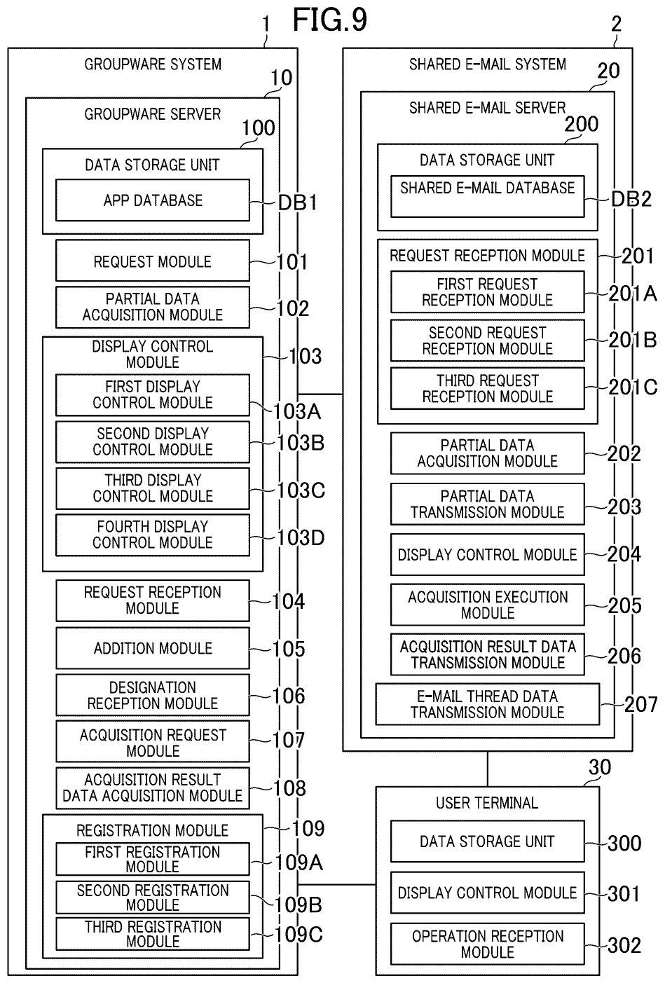

FIG. 9 is a diagram for illustrating an example of functions implemented in modification examples. For example, the groupware server 10 includes a request reception module 104, an addition module 105, a designation reception module 106, an acquisition request module 107, an acquisition result data acquisition module 108, and a registration module 109. The request reception module 104, the addition module 105, the designation reception module 106, the acquisition request module 107, the acquisition result data acquisition module 108, and the registration module 109 are each implemented by the control unit 11. For example, the shared e-mail server 20 includes a display control module 204, an acquisition execution module 205, an acquisition result data transmission module 206, and an e-mail thread data transmission module 207. The display control module 204, the acquisition execution module 205, the acquisition result data transmission module 206, and the e-mail thread data transmission module 207 are each implemented by the control unit 21.

### 6-1. Modification Examples of Groupware System

First, modification examples of the groupware system 1 are described.

### Modification Example 1-1

For example, when the user selects any shared e-mail from the list L226 of the shared e-mail screen SC2, the groupware server 10 may display the details of the selected shared e-mail in the shared e-mail portion P22 of the shared e-mail screen SC2. In another example, when the user selects a link to a specific shared e-mail link posted to a groupware thread or the like, the groupware server 10 may display the details of the selected shared e-mail in the shared e-mail portion P22 of the shared e-mail screen SC2.

For example, the groupware server 10 identifies which shared e-mail has been selected by the user based on the link to the shared e-mail in the list L226. When the domain of the shared e-mail service is included in the link, the screen on the shared e-mail service side is displayed on the user terminal 30 instead of the shared e-mail screen SC2 of the groupware, and hence in Modification Example 1-1, the link to the shared e-mail includes the domain of the groupware and the shared e-mail identification information.

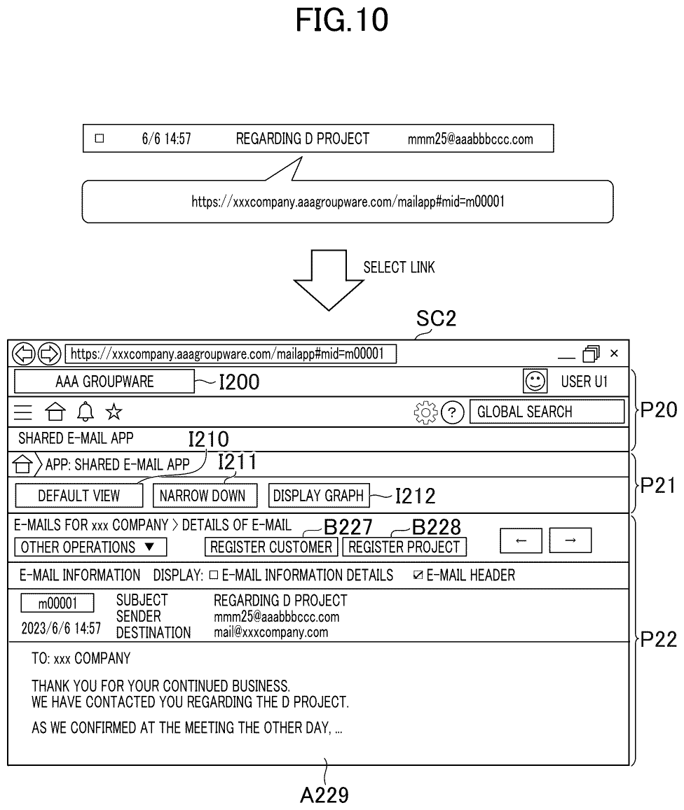

FIG. 10 is a view for illustrating an example of the link to the shared e-mail displayed in the shared e-mail portion P22. In the example of FIG. 10, the link to the shared e-mail displayed in the shared e-mail portion P22 includes the domain “xxxcompany.aaagroupware.com” of the groupware and the shared e-mail identification information “m00001”. Each link includes specific symbols such as “#” and “=”. This allows the groupware server 10 to identify which portion of the link is the shared e-mail identification information.

The partial data acquisition module 102 in Modification Example 1-1 acquires the partial data including such a link as illustrated in FIG. 10 from the shared e-mail system 2. In the example of FIG. 3, the partial data acquisition module 102 acquires the partial data including the link to each of a plurality of shared e-mails in the list L226. The respective links have the same domain portion, but differ in the shared e-mail identification information. A method of generating partial data by the shared e-mail system 2 is described later in Modification Example 2-1.

The groupware server 10 in Modification Example 1-1 includes the request reception module 104. The request reception module 104 receives various requests from the user terminal 30. For example, when the link to the shared e-mail is selected on the user terminal 30, the request reception module 104 receives a display request for the shared e-mail screen SC2 from the user terminal 30. The display request is data that allows the groupware server 10 to identify that display of the shared e-mail screen SC2 is requested. For example, the display request is a request such as an http request. The link to the shared e-mail includes the domain of the groupware, and hence, instead of the shared e-mail server 20, the groupware server 10 receives the display request.

The processing of each of the request module 101, the partial data acquisition module 102, and the first display control module 103A in Modification Example 1-1 is executed each time the display request is received. For example, when the request reception module 104 receives the display request from the user terminal 30, the request module 101 transmits the shared e-mail identification information included in the display request to the shared e-mail system 2. The shared e-mail system 2 executes processing in Modification Example 2-1 described later, generates partial data indicating the details of the shared e-mail indicated by the shared e-mail identification information, and transmits the partial data to the groupware system 1.

For example, the partial data acquisition module 102 acquires, from the shared e-mail system 2, the partial data indicating the details of the shared e-mail indicated by the shared e-mail identification information included in the link selected by the user. The first display control module 103A generates display data of the shared e-mail screen SC2 through use of an inline frame in the same manner as in the at least one embodiment. As illustrated in FIG. 10, the shared e-mail portion P22 of the shared e-mail screen SC2 shows the details of the shared e-mail indicated by the shared e-mail identification information included in the link selected by the user.

In the example of FIG. 10, the partial data includes a button B227 for the groupware server 10 to register information on the shared e-mail in the customer management app, a button B228 for the groupware server 10 to register information on the shared e-mail in the project management app, and a display area A229 that shows detailed information on the shared e-mail. Data corresponding to the display area A229 may be data having a format employed in a publicly-known shared e-mail service. In Modification Example 1-1, each time the user selects a link from the shared e-mail screen SC2 or another screen (for example, screen of a thread to which the link to the shared e-mail has been posted), the processing of each of the request module 101, the partial data acquisition module 102, and the first display control module 103A is repeated.

In Modification Example 1-1, the link to the shared e-mail displayed in the shared e-mail portion P22 includes the domain of the groupware and the shared e-mail identification information. The groupware system 1 receives the display request for the shared e-mail screen SC2 from the user terminal 30 when the link is selected on the user terminal 30. The processing of each of the request module 101, the partial data acquisition module 102, and the first display control module 103A is executed each time the display request is received. The groupware system 1 can display, on the user terminal 30, the shared e-mail under the domain of the groupware when the user selects the link to the shared e-mail. When the user terminal 30 that is currently accessing the domain of the groupware accesses another domain, the user may be confused, but the groupware system 1 can prevent such confusion of the user.

### Modification Example 1-2

In the at least one embodiment, an example in which the user uses the shared e-mail service as a groupware option is taken as an example. The shared e-mail service may be added as a plug-in within the groupware. The shared e-mail app described in the at least one embodiment is a type of plug-in in a sense that the user can add the shared e-mail app afterward. Plug-ins in Modification Example 1-2 include not only the shared e-mail app but also a plug-in that does not have a database function. Each plug-in may be a plug-in serving as an additional function within an app, or may be a plug-in serving as an additional function irrelevant to an app.

The plug-in is a groupware function (program) that can be added afterward by a user. The plug-in may have any format, for example, may be a ZIP file in which a plurality of files including a program are compressed. The data storage unit 100 stores plug-ins for various additional functions. For example, the data storage unit 100 may store various plug-ins such as not only a plug-in for shared e-mails but also a plug-in for creating an in-house portal page or a plug-in for a communication tool. The user can select any plug-in. The plug-in may be chargeable or free of charge.

The groupware system 1 according to Modification Example 1-2 includes the addition module 105. The addition module 105 adds the plug-in for shared e-mails for the groupware when the user who uses the groupware performs a predetermined plug-in addition operation. The user as used herein may be a person who has administrative authority in an organization, or may be a person who does not particularly have administrative authority. For example, the display control module 103 displays, on the user terminal 30, a list of plug-ins that can be added by the user. The user selects a plug-in to be added to the groupware used by the user or the organization from the list.

For example, when the user selects the plug-in for shared e-mails, the addition module 105 loads the plug-in stored in the data storage unit 100 onto the data storage unit 100 or another storage area in association with the organization ID of the organization of the user or the user ID of the user. The plug-in for shared e-mails may be loaded onto the user terminal 30. The processing of each of the request module 101, the partial data acquisition module 102, and the first display control module 103A in Modification Example 1-2 is executed based on the plug-in for shared e-mails. In Modification Example 1-2, it is assumed that code for a series of processing steps described in the at least one embodiment is described in the plug-in for shared e-mails. In Modification Example 1-2, the series of processing steps described in the at least one embodiment is executed based on the code of the plug-in for shared e-mails.

The groupware system 1 according to Modification Example 1-2 adds the plug-in for shared e-mails when the user performs a predetermined plug-in addition operation. The processing of each of the request module 101, the partial data acquisition module 102, and the first display control module 103A is executed based on the plug-in. The groupware system 1 can use the plug-in to implement the shared e-mail service serving as an option for the groupware. For example, the groupware system 1 provides the plug-in for shared e-mails only to users who wish to view the shared e-mails in the groupware, thereby being able to reduce waste of resources in the groupware. For example, the groupware system 1 can reuse a mechanism of another plug-in such as the plug-in for creating an in-house portal page, thereby being able to reduce the number of development steps for the groupware.

### Modification Example 1-3

For example, the user may be able to designate an HTML tag as a setting for the shared e-mail app. The HTML tag is reflected in screens of the shared e-mail app including the shared e-mail screen SC2. For example, the shared e-mail screen SC2 includes the HTML tag designated by the user. In Modification Example 1-3, when the user designates a predetermined HTML tag, the shared e-mail portion P22 is displayed in the shared e-mail app. The predetermined HTML tag is a character string that indicates that shared e-mails are to be displayed. The predetermined HTML tag is determined in advance by the groupware provider. When the user performs an operation for the setting for the shared e-mail app from the portal screen SC1, the shared e-mail screen SC2, or another screen, an app setting screen SC3 is displayed on the user terminal 30.

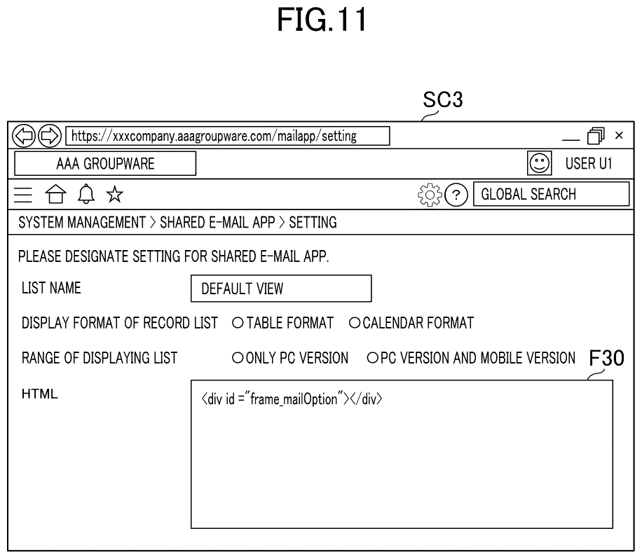

FIG. 11 is a view for illustrating an example of an app setting screen. For example, in the app setting screen SC3, an input form and the like for the user to designate the details of the content portion P21 of the shared e-mail screen SC2 are displayed. The user inputs the predetermined HTML tag into an input form field F30 that receives input of the HTML tag. In the example of FIG. 11, when the user inputs the HTML tag including a character string such as “frame_mailOption” into the input form field F30, the shared e-mail portion P22 is displayed on the shared e-mail screen SC2. The user can designate any HTML tag in the input form field F30.

The groupware system 1 according to Modification Example 1-3 includes the designation reception module 106. The designation reception module 106 receives the designation of the HTML tag indicating shared e-mails performed by the user who uses the groupware. In the example of FIG. 11, the designation reception module 106 receives the designation of the HTML tag through the input form field F30 of the app setting screen SC3. The designation reception module 106 may receive the designation of the HTML tag from another screen different from the app setting screen SC3. When the designation reception module 106 receives the designation of the HTML tag, the designation reception module 106 stores the designated HTML tag in the data storage unit 100 as the app setting data on the shared e-mail app.

The processing of each of the request module 101, the partial data acquisition module 102, and the first display control module 103A in Modification Example 1-3 is executed on condition that the HTML tag has been designated. For example, when the groupware server 10 receives the display request for the shared e-mail screen SC2 from the user terminal 30 of a certain user, the groupware server 10 refers to the setting for the shared e-mail app stored in the data storage unit 100. The groupware server 10 determines whether or not the predetermined HTML tag is designated in the setting for the shared e-mail app.

When the groupware server 10 does not determine that the predetermined HTML tag is designated in the setting for the shared e-mail app, the groupware server 10 does not execute the processing of at least one of the request module 101, the partial data acquisition module 102, or the first display control module 103A. In this case, the display control module 103 displays, on the user terminal 30, the shared e-mail screen SC2 that does not include the shared e-mail portion P22, or the shared e-mail screen SC2 that includes the shared e-mail portion P22 but does not show anything therein. Meanwhile, when the groupware server 10 determines that the predetermined HTML tag is designated in the setting for the shared e-mail app, the groupware server 10 executes the processing of each of the request module 101, the partial data acquisition module 102, and the first display control module 103A described in the at least one embodiment.

The user may be able to use the shared e-mail service as a groupware option in another app different from the shared e-mail app. For example, when the user designates the predetermined HTML tag from the app setting screen SC3 of the customer management app, the project management app, or another app, the shared e-mail portion P22 may be displayed on the screens of those apps. The processing of the request module 101, the partial data acquisition module 102, and the first display control module 103A in this case is as described in the at least one embodiment. In addition, for example, the user may be able to designate the predetermined HTML tag for another screen different from the screen of an app. In this case, the shared e-mail portion P22 is displayed on another screen different from the screen of an app.

The groupware system 1 according to Modification Example 1-3 receives the designation of the HTML tag indicating shared e-mails performed by the user. The processing of each of the request module 101, the partial data acquisition module 102, and the first display control module 103A is executed on condition that the HTML tag has been designated. The groupware system 1 can display the shared e-mail portion P22 on a screen of any app or another screen different from the screen of an app by designating the HTML tag for any app or any page.

### Modification Example 1-4

For example, the user may directly log in to the shared e-mail service. When the user logs in to the shared e-mail service, the shared e-mail system 2 displays, on the user terminal 30, the shared e-mail screen under the domain of the shared e-mail service. This shared e-mail screen is displayed by processing described later in Modification Example 2-2. This shared e-mail screen may be a screen employed in a publicly-known shared e-mail service.

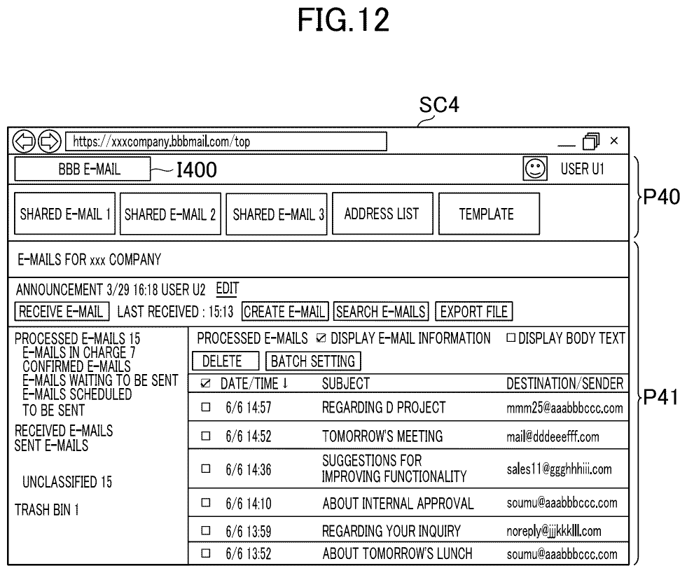

FIG. 12 is a view for illustrating an example of the shared e-mail screen displayed on the user terminal 30 when the user logs in to the shared e-mail service. As illustrated in FIG. 12, a shared e-mail screen SC4 in the shared e-mail service includes a header portion P40 specific to the shared e-mail service, and a shared e-mail portion P41 having the same or similar details as those of the shared e-mail portion P22. The header portion P40 is different from the header portion P20 of the shared e-mail screen SC2 in the groupware.

For example, a background color of the header portion P40 is a theme color of the shared e-mail service. The header portion P40 includes a shared e-mail image I400 for showing a name of the shared e-mail service or a logo thereof. The shared e-mail image I400 may be used as a background image of the header portion P40. The header portion P40 allows the user to intuitively understand that they have logged in to the shared e-mail service. For example, the user can intuitively understand that the shared e-mail system 2 is being accessed based on the shared e-mail image I400.

The first display control module 103A in Modification Example 1-4 displays, on the user terminal 30, the shared e-mail screen SC2 including the groupware portion from which the groupware is identifiable to the user who uses the groupware and the shared e-mail portion P22 from which the shared e-mail system 2 is unidentifiable to the user. The shared e-mail system 2 generates such partial data for the shared e-mail portion P22. Processing on the shared e-mail system 2 side is described later in Modification Example 2-3.

The wording “the groupware is identifiable to the user” indicates that the user can identify the groupware based on an appearance (outer appearance) of the groupware portion. In Modification Example 1-4, the groupware image I200 allows the user to visually identify the groupware, and hence the groupware portion including the groupware image I200 corresponds to the groupware portion from which the groupware is identifiable to the user. In addition, for example, the groupware portion including an illustration or the like of the groupware generated through use of CSS, the groupware portion having a background color that is the theme color of the groupware, or the groupware portion including text representing the groupware may correspond to the groupware portion from which the groupware is identifiable to the user.

The wording “the shared e-mail system 2 is unidentifiable to the user” indicates that the user cannot identify the shared e-mail system 2 based on an appearance (outer appearance) of the shared e-mail portion P22. In Modification Example 1-4, the user can visually identify the shared e-mail system 2 based on the shared e-mail image I400, and hence the shared e-mail portion P22 that does not include the shared e-mail image I400 corresponds to the shared e-mail portion P22 from which the shared e-mail system 2 is unidentifiable to the user. In addition, for example, the shared e-mail portion P22 that does not include an illustration or the like of the shared e-mail system 2 generated through use of CSS, the shared e-mail portion P22 having a background color that is not the theme color of the shared e-mail system 2, or the shared e-mail portion P22 that does not include text representing the shared e-mail system 2 may correspond to the shared e-mail portion P22 from which the shared e-mail system 2 is unidentifiable to the user.

For example, the partial data indicates the shared e-mail portion P22 having the same layout as that of the shared e-mail portion P41 without including the header portion P40 of the shared e-mail screen SC4 in the shared e-mail service. When a footer portion is present on the shared e-mail screen SC4, the partial data indicates the shared e-mail portion P22 having the same layout as that of the shared e-mail portion P41 without including the footer portion. The first display control module 103A displays the shared e-mail screen SC2 on the user terminal 30 based on such partial data.

The groupware system 1 according to Modification Example 1-4 displays, on the user terminal 30, the shared e-mail screen SC2 including the groupware portion from which the groupware is identifiable to the user and the shared e-mail portion P22 from which the shared e-mail system 2 is unidentifiable to the user. The groupware image I200 allows the user to intuitively understand that the shared e-mail screen SC2 is a screen of the groupware. The shared e-mail image I400 is not displayed on the shared e-mail screen SC2, thereby being able to prevent the user from misunderstanding that the user has logged in to the shared e-mail service.

### Modification Example 1-5

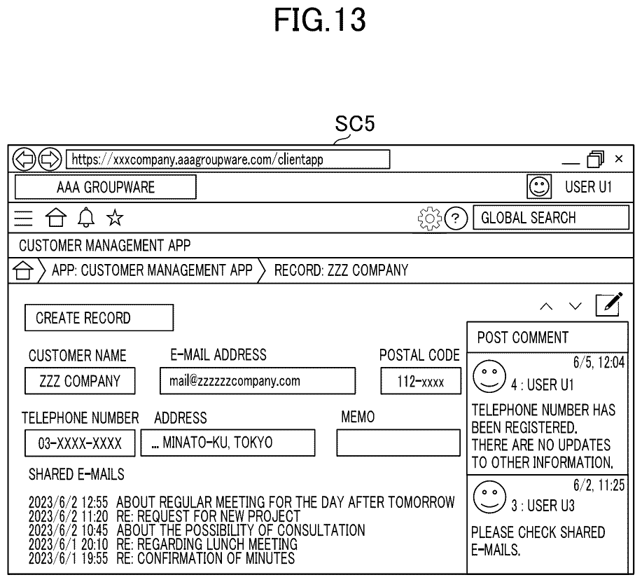

For example, when the user selects the customer management app from the list L110, a customer management screen SC5 that shows the customer management app is displayed on the user terminal 30. FIG. 13 is a view for illustrating an example of the customer management screen SC5. For example, customer information stored in a record of the customer management app is displayed on the customer management screen SC5. The user can store new information in the record or change information stored in the record from the customer management screen SC5. Shared e-mails relating to a currently displayed customer may be displayed on such a customer management screen SC5.

The groupware system 1 according to Modification Example 1-5 includes the acquisition request module 107, the acquisition result data acquisition module 108, and a second display control module 103B. The acquisition request module 107 requests the shared e-mail system 2 to acquire shared e-mails based on an e-mail address registered in the customer management app, which manages customer information on the user who uses the groupware. The acquisition as used herein refers to a concept including various kinds of processing such as searching, lookup, and narrowing down. For example, when the user selects a record of the customer management app, the acquisition request module 107 acquires the e-mail address stored in the record. The user may manually designate the e-mail address of a shared e-mail to be acquired.

For example, the acquisition request module 107 transmits, to the shared e-mail system 2, data having a predetermined format including the e-mail address of a shared e-mail to be acquired. The shared e-mail system 2 acquires all or a part of the shared e-mails of the e-mail address from the shared e-mail database DB2. The shared e-mail of the e-mail address is a shared e-mail having the e-mail address set in the destination, the CC, the BCC, or the sender. The shared e-mail system 2 transmits the shared e-mail data of the acquired shared e-mail to the groupware system 1.

The acquisition result data acquisition module 108 acquires acquisition result data indicating acquisition results of the shared e-mails from the shared e-mail system 2. The acquisition result data is only required to include some information relating to the shared e-mails, and may have any format. For example, the acquisition result data may be the same as the shared e-mail data, or may include only partial information such as the subjects and the links. The acquisition result data acquisition module 108 may store the acquisition result data in the record of the customer management app, or may not particularly store the acquisition result data in the record.

The second display control module 103B displays the customer management screen SC5 including the customer information and the acquisition results indicated by the acquisition result data on the user terminal 30 based on the customer management app. In the example of FIG. 13, the second display control module 103B generates display data of the customer management screen SC5 such that the customer information (for example, the customer name and the e-mail address) stored in the app database DB1 is placed at a first position and the acquisition results indicated by the acquisition result data are placed at a second position different from the first position (for example, lower than the position of the customer information).

The second display control module 103B transmits the display data of the customer management screen SC5 to the user terminal 30. When the user terminal 30 receives the display data, the user terminal 30 displays the customer management screen SC5 on the display unit 35. In the example of FIG. 13, the subjects of the shared e-mails relating to the e-mail addresses stored in the record being displayed are displayed in chronological order on the customer management screen SC5. When the user selects the subject of a shared e-mail displayed on the customer management screen SC5, the shared e-mail screen SC2 that shows the details of the shared e-mail is displayed on the user terminal 30 in the same manner as in Modification Example 1-1.

The groupware system 1 according to Modification Example 1-5 requests the shared e-mail system 2 to acquire shared e-mails based on the e-mail address registered in the customer management app. The groupware system 1 acquires the acquisition result data from the shared e-mail system 2. The groupware system 1 displays the customer management screen SC5 including the customer information and the acquisition results indicated by the acquisition result data on the user terminal 30 based on the customer management app. This allows the user to access the information on the shared e-mails even through use of the customer management app in the groupware.

### Modification Example 1-6

For example, the user may be able to register information such as the e-mail address of a shared e-mail in the customer management app from the shared e-mail screen SC2. The groupware system 1 includes the registration module 109. The registration module 109 registers various kinds of data in the groupware in the data storage unit 100. For example, the registration module 109 registers data relating to an app in the app.

For example, the registration module 109 includes a first registration module 109A. The first registration module 109A registers, when a predetermined registration operation is performed on the shared e-mail screen SC2, new customer information in the customer management app, which manages the customer information on the user who uses the groupware, based on the shared e-mail displayed in the shared e-mail portion P22. The registration operation may be any operation performed from the shared e-mail screen SC2. For example, when a button labeled “Register customer information” is displayed on the shared e-mail screen SC2, selecting the button may correspond to the registration operation.

For example, in a case in which the details of the shared e-mail are displayed on the shared e-mail screen SC2 as in Modification Example 1-1, when the user performs the registration operation by selecting the button B227, the first registration module 109A acquires an e-mail address in the destination, the CC, the BCC, or the sender of the shared e-mail being displayed. In addition to the e-mail address, the first registration module 109A may also acquire at least one of a display name of the e-mail address or a signature in the body text of the shared e-mail. Those pieces of information may be included in the partial data, or the first registration module 109A may request the shared e-mail system 2 for those pieces of information. The first registration module 109A registers those pieces of information in a new record or an existing record of the customer management app.

The groupware system 1 according to Modification Example 1-6 registers new customer information in the customer management app based on the shared e-mail displayed in the shared e-mail portion P22 when a predetermined registration operation is performed on the shared e-mail screen SC2. The groupware system 1 allows the customer information to be registered in the customer management app through a simple operation, thereby being able to increase the convenience of the user.

### Modification Example 1-7

For example, when the shared e-mail of the e-mail address registered in the customer management app is displayed on the shared e-mail screen SC2, the customer management screen SC5 may be displayed from the shared e-mail screen SC2. The groupware system 1 according to Modification Example 1-7 includes a third display control module 103C. The third display control module 103C displays the customer management screen SC5 of the customer management app, which manages the customer information on the user who uses the groupware, on the user terminal 30 based on the shared e-mail displayed in the shared e-mail portion P22 when a predetermined display operation is performed on the shared e-mail screen SC2. The display operation may be any operation performed from the shared e-mail screen SC2. For example, when a button labeled “View customer information” is displayed on the shared e-mail screen SC2, selecting the button may correspond to the display operation.

For example, in a case in which the details of the shared e-mail are displayed on the shared e-mail screen SC2 as in Modification Example 1-1, the user performs the display operation by selecting a button labeled “View customer information” that is not shown in FIG. 10. The third display control module 103C acquires an e-mail address in the destination, the CC, the BCC, or the sender of the shared e-mail being displayed. In addition to the e-mail address, the third display control module 103C may also acquire at least one of the display name of the e-mail address or the signature in the body text of the shared e-mail. Those pieces of information may be included in the partial data, or the third display control module 103C may request the shared e-mail system 2 for those pieces of information. The third display control module 103C uses those pieces of information as keys to acquire the record of the customer management app. The third display control module 103C displays, on the user terminal 30, the customer management screen SC5 that shows the acquired information.

The groupware system 1 according to Modification Example 1-7 displays the customer management screen SC5 on the user terminal based on the shared e-mail displayed in the shared e-mail portion P22 when a predetermined display operation is performed on the shared e-mail screen SC2. The groupware system 1 allows the user to view the customer information on the customer management screen SC5 through a simple operation, thereby being able to increase the convenience of the user.

### Modification Example 1-8

For example, an e-mail thread of shared e-mails relating to each individual project may be registered in the project management app. In Modification Example 1-8, one e-mail thread is registered for one project, but a plurality of e-mail threads may be registered for one project. The groupware system 1 includes a second registration module 109B and a fourth display control module 103D.

The second registration module 109B registers the e-mail thread of the shared e-mails in the project management app, which manages projects of the user who uses the groupware. The second registration module 109B registers the e-mail thread in the management by project app registering e-mail thread identification information that enables the groupware server 10 to identify the e-mail thread in a record of the project management app. The e-mail thread identification information may be a reference (list of message IDs of relevant shared e-mails) included in the header of the shared e-mail, or may be uniquely issued by the shared e-mail server 20. The e-mail thread to be registered is designated by the user. The second registration module 109B registers information such as an e-mail thread ID and the shared e-mail identification information in the project management app.

For example, the second registration module 109B registers the e-mail thread of a shared e-mail selected from the shared e-mail portion P22 of the shared e-mail screen SC2 in the project management app. As illustrated in FIG. 3, when the list L226 of a plurality of shared e-mails is displayed in the shared e-mail portion P22, the second registration module 109B registers at least one e-mail thread selected by the user from the list L226 in the project management app. It is assumed that the user also designates the project for which the e-mail thread is to be registered. In a case in which the details of one certain shared e-mail are displayed in the shared e-mail portion P22 as in Modification Example 1-1, the second registration module 109B registers the e-mail thread being displayed in the project management app when the user performs a predetermined operation on the shared e-mail screen SC2 (for example, when the user selects the button B228 of FIG. 10).

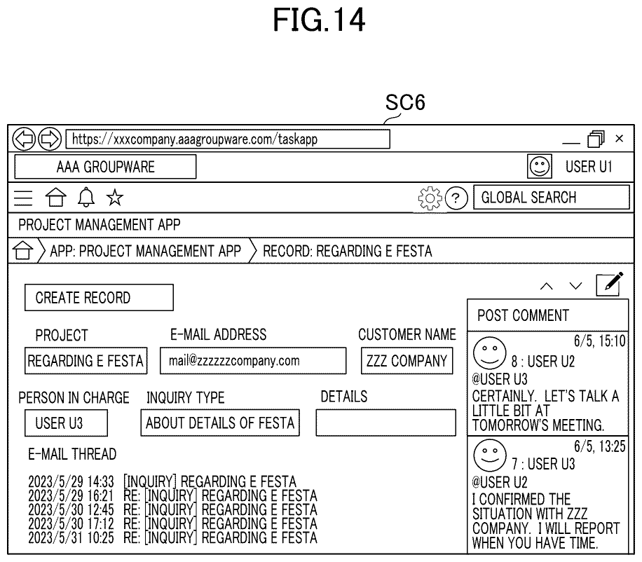

FIG. 14 is a view for illustrating an example of a project management screen. The fourth display control module 103D displays a project management screen SC6 including the e-mail thread on the user terminal 30 based on the project management app. It is assumed that data required for displaying the project management screen SC6 is stored in advance in the data storage unit 100. The fourth display control module 103D uses this data to generate display data of the project management screen SC6. The fourth display control module 103D may request the shared e-mail system 2 for information on the latest e-mail thread each time the user requests display of the project management screen SC6. In response to the request, the shared e-mail system 2 refers to the shared e-mail database DB2 to transmit the information on the latest e-mail thread to the groupware system 1.

For example, when the user selects any record in the project management app, the fourth display control module 103D acquires the details of this record. The fourth display control module 103D generates display data of the project management screen SC6 based on the details of the record. When an e-mail thread is registered in the record, the fourth display control module 103D generates display data of the project management screen SC6 that shows subjects included in the e-mail thread as illustrated in FIG. 14. The fourth display control module 103D displays the project management screen SC6 on the user terminal 30 by transmitting the display data of the project management screen SC6 to the user terminal 30. It is assumed that the display data of the project management screen SC6 includes the link to each individual shared e-mail belonging to the e-mail thread.

The processing of each of the request module 101, the partial data acquisition module 102, and the first display control module 103A in Modification Example 1-8 is executed when an e-mail thread is selected on the project management screen SC6. For example, when the user selects a link to a shared e-mail belonging to an e-mail thread on the project management screen SC6, the user terminal 30 transmits the display request for the shared e-mail screen SC2 to the groupware server 10 based on the link to the selected shared e-mail. The groupware server 10 receives the display request for the shared e-mail screen SC2 from the user terminal 30. The subsequent processing of each of the request module 101, the partial data acquisition module 102, and the first display control module 103A is the same as that in Modification Example 1-1.

The groupware system 1 according to Modification Example 1-8 registers the e-mail thread of a shared e-mail in the project management app. The groupware system 1 displays the project management screen SC6 including an e-mail thread on the user terminal 30 based on the project management app. The processing of each of the request module 101, the partial data acquisition module 102, and the first display control module 103A is executed when an e-mail thread is selected on the project management screen SC6. The e-mail thread is displayed on the project management screen SC6, and hence the user can easily manage the project. When the user selects an e-mail thread, the shared e-mail screen SC2 that shows the shared e-mail belonging to the e-mail thread is displayed on the user terminal 30, and hence the convenience of the user is increased. The user can view the shared e-mail screen SC2 of the groupware from the project management screen SC6 of the groupware without transitioning to another domain.

Further, the groupware system 1 registers the e-mail thread of a shared e-mail selected from the shared e-mail portion P22 of the shared e-mail screen SC2 in the project management app. The user can view the shared e-mail on the shared e-mail screen SC2 and directly register the e-mail thread of the shared e-mail in the project management app, and hence the convenience of the user is increased.

### Modification Example 1-9

For example, in Modification Example 1-8, the second registration module 109B may register an e-mail thread of a shared e-mail designated on the project management screen SC6 in the project management app. It is assumed that an input form for the user to designate an e-mail thread that the user wishes to register in the project management app is displayed on the project management screen SC6 in Modification Example 1-9. When the user designates a link to a shared e-mail in the input form, the second registration module 109B registers the e-mail thread to which the shared e-mail belongs in the project management app. The second registration module 109B may request the shared e-mail system 2 for information that identifies the e-mail thread based on the shared e-mail identification information on the shared e-mail.

The groupware system 1 according to Modification Example 1-9 registers an e-mail thread of a shared e-mail designated on the project management screen SC6 in the project management app. The user can designate the e-mail thread to directly register the e-mail thread in the project management app while viewing the project on the project management screen SC6, and hence the convenience of the user is increased.

### Modification Example 1-10

For example, when information such as the e-mail address of a shared e-mail is registered in the customer management app as in Modification Example 1-6, the user may be able to designate a correspondence relationship between each of a plurality of pieces of information included in the shared e-mail and each of a plurality of fields of the customer management app. It is assumed that each correspondence relationship designated by the user is registered in the app database DB1 as the app setting data on the customer management app. The groupware system 1 according to Modification Example 1-10 includes a third registration module 109C.

The third registration module 109C registers the pieces of information included in the shared e-mail in the app based on associations between fields of the app, which are set for each app in the groupware, and items included in the shared e-mail. In Modification Example 1-10, the customer management app is described as an example of the app, but the app may be another app different from the customer management app. For example, the third registration module 109C may register pieces of information included in the shared e-mail in the project management app, the shared e-mail app, or another app based on associations designated in advance.

For example, for each item included in the header of the shared e-mail, the user designates which field a piece of information in this item corresponds to. Assuming that the customer management app has fields such as an e-mail address, a company name, a customer name, and a name of a person in charge, the user designates which one of those fields each item included in the header of the shared e-mail corresponds to. Each correspondence relationship designated by the user is indicated in advance in the app setting data. The third registration module 109C registers a piece of information in each item included in the header of the shared e-mail corresponding to the record of the customer management app as a value of the field corresponding to this item.

The groupware system 1 according to Modification Example 1-10 registers the pieces of information included in the shared e-mail in the app based on the associations between the fields of the app, which are set for each app in the groupware, and the items included in the shared e-mail. The groupware system 1 can register each item included in the shared e-mail in an optimal field.

### Modification Example 1-11

For example, the user may create an e-mail to be transmitted from the shared e-mail app through use of a template app in which a template for a shared e-mail is registered. The template app may be prepared from the beginning as a default app, or may be added afterward by the user. The template app may be created by the user.

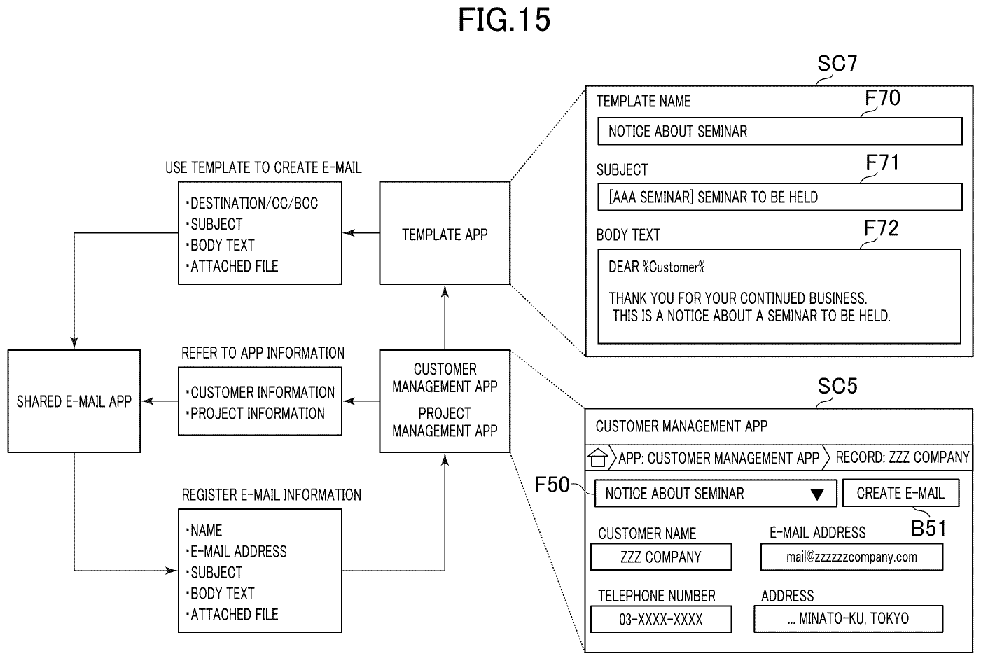

FIG. 15 is a diagram for illustrating an example of a relationship between the template app and other apps. In the example of FIG. 15, the shared e-mail app, the customer management app, and the project management app are illustrated as the other apps. For example, the data storage unit 100 stores data indicating records of the template app. Each record of the template app stores data of a template created by the user.

In Modification Example 1-11, the template app is displayed in the list L110 of the portal screen SC1 of FIG. 2 as one of the apps that can be used by the user. For example, when the user selects the template app from the list L110, the user terminal 30 displays a template screen SC7 on the display unit 35 as illustrated in FIG. 15. In FIG. 15, the template screen SC7 and the customer management screen SC5 are simplified.

For example, the user inputs a template name into an input form field F70. The user inputs a subject into an input form field F71. The user inputs body text into an input form field F72. The user can register any data as a template in the template app. Data that can be registered as a template by the user is not limited to the template name, the subject, and the body text. For example, the user can n register an attached file, a destination, a CC, a BCC, a format such as a font, a tag such as an importance level, an e-mail format such as HTML, or other data in the template app.

On the customer management screen SC5 in Modification Example 1-11, an input form field F50 for the user to select a template and a button B51 for the user to create an e-mail are displayed. When a plurality of templates are registered in the template app, the user selects any one of the plurality of templates from the input form field F50. When the user selects the button B51, the groupware server 10 creates an e-mail based on the customer management app, the template app, and the shared e-mail app.

In the example of FIG. 15, a variable “% Customer %” is designated as a field code (field name) in the body text of the template. For example, the variable represents a field code of the customer name in the customer management app. The groupware server 10 uses data of the template registered in the template app and the customer name registered in the customer management app to create an e-mail in which a customer name “ZZZ Company” being displayed on the customer management screen SC5 is inserted in the variable “% Customer %” portion of the body text of the template.

The user can designate any field code of the customer management app as the variable. The field code that can be designated by the user as the variable is not limited to the customer name. For example, the user may designate the name of the person in charge, the e-mail address, the telephone number, the address, or another field code as the variable. The user may designate the field code as the variable not only in the body text of the template but also in another portion such as the subject of the template. The field code may be common to a plurality of apps. For example, the variable “% Customer %” of FIG. 15 may represent the field code of the customer name in the project management app.

In another case, the user may create an e-mail by selecting a template from the project management screen SC6 instead of the customer management screen SC5. In this case as well, when a variable is designated in the template, the groupware server 10 uses data of the template registered in the template app and project information (for example, project name, customer name, or person in charge of FIG. 14) registered in the project management app to create an e-mail in which the project information being displayed on the project management screen SC6 is inserted in the variable portion of the body text of the template.

Further, the user may be able to select a template and create an e-mail on another app different from the customer management app and the project management app. When the user creates an e-mail from the template, the destination, the CC, and the BCC of the e-mail may be designated by the user, or may be defined in the template. In addition, in FIG. 15, a flow in which the information (for example, name, e-mail address, subject, body text, or attached file) on the shared e-mail is registered in the customer management app or the project management app from the shared e-mail app is also illustrated. This flow is as described above.

Further, when the user does not particularly designate a variable, the groupware server 10 may create an e-mail based on the template app without referring to the customer management app or the project management app. The groupware server 10 may create an e-mail based on at least the template app and the shared e-mail app. When the user designates a variable in the template, the groupware server 10 may create an e-mail by acquiring data corresponding to the variable from the customer management app, the project management app, or another app.

For example, when the user instructs to transmit an e-mail from the shared e-mail app, the groupware server 10 requests the shared e-mail system 2 to transmit an e-mail created based on the template. When the shared e-mail server 20 receives the request, the shared e-mail server 20 transmits the e-mail created based on the template. A method itself of transmitting the e-mail may be any one of various publicly-known methods. The shared e-mail server 20 transmits the e-mail created based on the template to each of addresses in the destination, the CC, and the BCC.

The groupware system 1 according to Modification Example 1-11 creates an e-mail based on the template app. This allows the user to easily use the template for an e-mail from the groupware, and hence the groupware system 1 can increase the convenience of the user.

### 6-2. Modification Examples of Shared E-Mail System

Next, modification examples of the shared e-mail system 2 are described.

### Modification Example 2-1

For example, as in Modification Example 1-1, the link to each shared e-mail displayed in the shared e-mail portion P22 may include the domain of the groupware and the shared e-mail identification information. The partial data acquisition module 202 in Modification Example 2-1 generates a link to each shared e-mail displayed in the shared e-mail portion P22. It is assumed that data representing the domain portion of the groupware, which is a part of the link, is stored in the data storage unit 200.

For example, the partial data acquisition module 202 identifies the domain portion of the groupware based on the data stored in the data storage unit 200. In the example of FIG. 10, the partial data acquisition module 202 designates the portion “xxxcompany.aaagroupware.com” as the domain of the groupware. The partial data acquisition module 202 refers to the shared e-mail database DB2 and acquires the shared e-mail identification information on the shared e-mail displayed in the shared e-mail portion.

For example, the partial data acquisition module 202 generates a link by placing a predetermined symbol (for example, “#”, “?”, or “=”) after the domain of the groupware and placing shared e-mail identification information after the predetermined symbol. The partial data acquisition module 202 generates links corresponding to the number of shared e-mails displayed in the shared e-mail portion (in the example of FIG. 3, five links displayed in the list L226). The partial data acquisition module 202 generates, as the partial data, HTML data of the shared e-mail portion P22 including those links. The processing of the first request reception module 201A and the partial data transmission module 203 is the same as that in the at least one embodiment.

The processing of each of the first request reception module 201A, the partial data acquisition module 202, and the partial data transmission module 203 in Modification Example 2-1 is executed each time a link is selected on the user terminal 30 and the groupware system 1 receives the display request for the shared e-mail screen SC2 from the user terminal 30. For example, the first request reception module 201A receives the request made by the request module 101 as described in Modification Example 1-1. The partial data acquisition module 202 executes the processing described above to generate HTML data of the shared e-mail portion P22 including the links as the partial data. The partial data transmission module 203 transmits the partial data to the groupware system 1.

In the shared e-mail system 2 in Modification Example 2-1, the link to each shared e-mail displayed in the shared e-mail portion P22 includes the domain of the groupware and the shared e-mail identification information. The processing of each of the first request reception module 201A, the partial data acquisition module 202, and the partial data transmission module 203 is executed each time a link is selected on the user terminal 30 and the groupware system 1 receives the display request for the shared e-mail screen SC2 from the user terminal 30. When the user selects the link to the shared e-mail, the shared e-mail system 2 can display the shared e-mail on the user terminal 30 under the domain of the groupware. When the user terminal 30 that is currently accessing the domain of the groupware accesses another domain, the user may be confused, but the shared e-mail system 2 can prevent such confusion of the user.

### Modification Example 2-2

For example, the processing of each of the first request reception module 201A, the partial data acquisition module 202, and the partial data transmission module 203 described in the at least one embodiment is executed when the user logs in to the groupware. Meanwhile, when the user directly logs in to the shared e-mail service as in Modification Example 1-4, the shared e-mail screen SC4 having the same or similar details as those of the shared e-mail portion P22 is displayed on the user terminal 30. The shared e-mail screen SC4 is as described in Modification Example 1-4. The shared e-mail system 2 in Modification Example 2-2 includes the display control module 204.

When the user logs in to the shared e-mail system 2, the display control module 204 displays the shared e-mail screen SC4 that shows the shared e-mails on the user terminal 30 based on a link that includes the domain of the shared e-mail system 2 and t the shared e-mail identification information without including the domain of the groupware. The display control module 204 generates display data of the shared e-mail screen SC4, and transmits the display data of the shared e-mail screen SC4 to the user terminal 30. When the user terminal 30 receives the display data of the shared e-mail screen SC4, the user terminal 30 displays the shared e-mail screen SC4 on the display unit 35. A series of those processing steps may be processing employed in a publicly-known shared e-mail service.

The partial data acquisition module 202 in Modification Example 2-2 generates partial data for the shared e-mail portion P22 having a layout different from that of the shared e-mail portion P41 of the shared e-mail screen SC4 displayed when the user directly logs in to the shared e-mail service. For example, the partial data acquisition module 202 generates partial data for the shared e-mail portion P22 that does not include the shared e-mail image I400. In addition, for example, the partial data acquisition module 202 may generate partial data for the shared e-mail portion P22 having a background color that is not the theme color of the shared e-mail service.

When the user logs in to the shared e-mail system 2, the shared e-mail system 2 in Modification Example 2-2 displays the shared e-mail screen SC4 that shows the shared e-mails on the user terminal 30 based on a link that includes the domain of the shared e-mail system 2 and the shared e-mail identification information without including the domain of the groupware. The shared e-mail system 2 can provide the shared e-mail screen SC4 to the user who has directly logged in to the shared e-mail service. For example, the shared e-mail system 2 can also cause the layout of the shared e-mail portion P22 and the layout of the shared e-mail portion P41 to differ from each other. Thus, the shared e-mail system 2 can display the shared e-mail portion P22 on the user terminal 30 in a display mode specific to the groupware, or can display the shared e-mail portion P41 on the user terminal 30 in a display mode specific to the shared e-mail service.

### Modification Example 2-3

For example, as in Modification Example 1-4, the shared e-mail screen SC4 includes the shared e-mail image I400 from which the shared e-mail system 2 is identifiable to the user. As described to some extent in Modification Example 2-2, the shared e-mail system 2 may include the display control module 204 that displays the shared e-mail screen SC4 from which the shared e-mail system 2 is identifiable to the user on the user terminal 30 when the user logs in to the shared e-mail system 2. The wording “the shared e-mail system 2 is identifiable to the user” has a meaning opposite to that of the wording “the shared e-mail system 2 is unidentifiable to the user” described in Modification Example 1-4, and hence it suffices to read the description in Modification Example 1-4 so that the description has the opposite meaning.

The partial data acquisition module 202 in Modification Example 2-3 acquires the partial data indicating the shared e-mail portion P22 from which the shared e-mail system 2 is unidentifiable to the user. In Modification Example 2-3, in the same manner as in Modification Example 1-4, the case in which the shared e-mail portion P22 that does not include the shared e-mail image I400 corresponds to the shared e-mail portion P22 from which the shared e-mail system 2 is unidentifiable to the user is taken as an example. The partial data acquisition module 202 may acquire the partial data indicating the shared e-mail portion P22 that does not include the shared e-mail image I400. The shared e-mail portion P22 does not include the shared e-mail image I400, and thus has an appearance different from that of the shared e-mail portion P41. The partial data acquisition module 202 may acquire the partial data for the shared e-mail portion P22, such as another example (the shared e-mail portion P22 that does not include an illustration or the like of the shared e-mail system 2 generated through use of CSS, or another example) described in Modification Example 1-4.

When the shared e-mail image I400 is displayed in the shared e-mail portion P22 of the shared e-mail screen SC2, the user may misunderstand that the user has logged in to the shared e-mail service. In this respect, the shared e-mail system 2 in Modification Example 2-3 can display, on the user terminal 30, the shared e-mail screen SC2 including such a shared e-mail portion P22 as to prevent the user who has logged in to the groupware from misunderstanding that the user has logged in to the shared e-mail service.

### Modification Example 2-4

For example, the partial data acquisition module 202 may acquire the partial data indicating the shared e-mail portion having a portion from which the shared e-mail system 2 is identifiable to the user on the shared e-mail screen SC4 that is displayed when the user logs in to the shared e-mail system 2 replaced so that the groupware is identifiable to the user therefrom. In Modification Example 2-4, the partial data acquisition module 202 acquires the partial data indicating the shared e-mail portion P22 having the shared e-mail image I400 replaced by the groupware image I200 from which the groupware is identifiable to the user. The data storage unit 200 in Modification Example 2-4 stores the image data of the groupware image I200. The partial data acquisition module 202 generates partial data indicating the shared e-mail portion P22 including the groupware image I200 based on the image data.

The partial data acquisition module 202 can place the groupware image I200 at any position in the shared e-mail portion P22. For example, the partial data acquisition module 202 may place the groupware image I200 at a position spaced apart by less than a predetermined distance from an upper end of the shared e-mail portion P22, or may place the groupware image I200 in the list L226. Instead of including the groupware image I200 in the partial data, the partial data acquisition module 202 may generate the partial data so that the background color of the shared e-mail portion P22 is the theme color of the groupware. Information indicating the background color of the shared e-mail portion P22 is indicated in the partial data. In addition, for example, the partial data acquisition module 202 may execute the replacement in the same manner as in another example of the wording “the groupware is identifiable to the user” described in Modification Example 1-4.

The shared e-mail system 2 in Modification Example 2-4 acquires the partial data indicating the shared e-mail portion P22 that has been subjected to the replacement as described above. The shared e-mail system 2 can display, on the user terminal 30, the shared e-mail screen SC2 including the shared e-mail portion P22 that allows the user who has logged in to the groupware to intuitively understand that the user has logged in to the groupware.

### Modification Example 2-5

For example, when the user selects a record of the customer management app in Modification Example 1-5, the shared e-mail system 2 may acquire shared e-mails to be displayed on the customer management screen SC5. The meaning of the “acquisition” as used in Modification Example 2-5 is as described in Modification Example 1-5. In Modification Example 2-5, processing to be performed on the shared e-mail system 2 side in Modification Example 1-5 is described. The shared e-mail system 2 in Modification Example 2-5 includes a second request reception module 201B, the acquisition execution module 205, and the acquisition result data transmission module 206.

The second request reception module 201B receives, from the groupware system 1, a request to acquire shared e-mails based on an e-mail address registered in the customer management app, which manages the customer information on the user who uses the groupware. The second request reception module 201B receives a request made by the acquisition request module 107 as described in Modification Example 1-5. As described in Modification Example 1-5, the request made by the acquisition request module 107 includes an e-mail address stored in a record of the customer management app that has been selected by the user.

The acquisition execution module 205 acquires the shared e-mails when the second request reception module 201B receives the request. For example, the acquisition execution module 205 acquires shared e-mails that are to be displayed on the customer management screen SC5 from the shared e-mail database DB2 based on an e-mail address included in the request received by the second request reception module 201B. The acquisition execution module 205 acquires shared e-mails having the e-mail address set in the destination, the CC, the BCC, or the sender.

The acquisition result data transmission module 206 transmits the results of the acquisition executed by the acquisition execution module 205 to the groupware system 1. The acquisition results are data having a predetermined format. The data includes the information on the shared e-mail acquired by the acquisition execution module 205. For example, the data includes the subject of each of the acquired shared e-mails, at least a part of the body text of each shared e-mail, a name of the attached file of each shared e-mail, or other information. The acquisition result data transmission module 206 refers to the shared e-mail database DB2 to acquire those pieces of information, and transmits the information as the acquisition result data.

The shared e-mail system 2 in Modification Example 2-5 receives, from the groupware system 1, a request to acquire shared e-mails based on an e-mail address registered in the customer management app. The shared e-mail system 2 acquires the shared e-mails when the shared e-mail system 2 receives the request. The shared e-mail system 2 transmits the results of the acquisition executed by the acquisition execution module 205 to the groupware system 1. This allows the user to access the information on the shared e-mails even through use of the customer management app in the groupware.

### Modification Example 2-6

For example, the shared e-mail system 2 may generate, in Modification Example 1-6, partial data for the shared e-mail portion P22 that allows the user to register the information on the shared e-mail in the customer management app. The partial data acquisition module 202 in Modification Example 2-6 acquires the partial data indicating the shared e-mail portion P22 that allows the user to instruct the customer management app, which manages the customer information on the user, to register new customer information based on the shared e-mail displayed in the shared e-mail portion P22. For example, the partial data acquisition module 202 acquires the partial data indicating the shared e-mail portion P22 including a registration image for the user to instruct the registration.

For example, the partial data acquisition module 202 generates partial data indicating the shared e-mail portion P22 including the button B227 of FIG. 10. It is assumed that a link for the button B227 includes the groupware domain. Thus, when the user selects the button B227, the user terminal 30 requests the groupware server 10 to register the information on the shared e-mail in the customer management app. The registration image is not limited to the button B227, and may be another image such as an icon. In addition to the registered image, the partial data acquisition module 202 may also use an illustration that can be displayed through use of CSS, text including the link, or another user interface part, to thereby acquire the partial data indicating the shared e-mail portion P22 that allows the user to instruct the above-mentioned registration.

The shared e-mail system 2 in Modification Example 2-6 acquires the partial data indicating the shared e-mail portion P22 that allows the user to instruct the customer management app to register new customer information based on the shared e-mail displayed in the shared e-mail portion P22. The shared e-mail system 2 can register the customer information in the customer management app through a simple operation, thereby being able to increase the convenience of the user.

### Modification Example 2-7

For example, the shared e-mail system 2 may generate, in Modification Example 1-7, partial data for the shared e-mail portion P22 that allows the user to display the customer management screen SC5 from the shared e-mail screen SC2. The partial data acquisition module 202 in Modification Example 2-7 acquires the partial data indicating the shared e-mail portion P22 that allows the user to instruct display of the customer management screen SC5 of the customer management app, which manages the customer information on the user, the display being based on the shared e-mail displayed in the shared e-mail portion P22. For example, the partial data acquisition module 202 acquires the partial data indicating the shared e-mail portion P22 including a display image for the user to instruct the display.

For example, the partial data acquisition module 202 generates partial data indicating the shared e-mail portion P22 including the button described in Modification Example 1-7. It is assumed that a link for the button includes the domain of the groupware. Thus, when the user selects the button, the user terminal 30 transmits a display request for a customer management screen to the groupware server 10. The display image is not limited to the button, and may be another image such as an icon. In addition to the display image, the partial data acquisition module 202 may also use an illustration that can be displayed through use of CSS, text including the link, or another user interface part, to thereby acquire the partial data indicating the shared e-mail portion P22 that allows the user to instruct the above-mentioned display.

The shared e-mail system 2 in Modification Example 2-7 acquires the partial data indicating the shared e-mail portion P22 that allows the user to instruct display of the customer management screen SC5 of the customer management app, which manages the customer information on the user who uses the groupware, the display being based on the shared e-mail displayed in the shared e-mail portion P22. The shared e-mail system 2 allows the user to view the customer information on the customer management screen SC5 through a simple operation, thereby being able to increase the convenience of the user.

### Modification Example 2-8

For example, when the user selects a record of the project management app in Modification Example 1-8, the shared e-mail system 2 may acquire an e-mail thread to be displayed on the project management screen SC6. In Modification Example 2-8, processing to be performed on the shared e-mail system 2 side in Modification Example 1-8 is described. The shared e-mail system 2 in Modification Example 2-8 includes a third request reception module 201C and the e-mail thread data transmission module 207.

The third request reception module 201C receives, from the groupware system 1, a request for e-mail thread data indicating an e-mail thread of shared e-mails to be registered in the project management app, which manages the projects of the user. When the user selects a record of the project management app, the groupware server 10 transmits an acquisition request for an e-mail thread to the shared e-mail system 2. The third request reception module 201C receives the acquisition request. For example, the acquisition request includes the e-mail thread ID registered in the record selected by the user.

The e-mail thread data transmission module 207 transmits the e-mail thread data to the groupware system 1 when the third request reception module 201C receives the request. For example, the e-mail thread data transmission module 207 acquires an e-mail thread that is to be displayed on the customer management screen SC5 from the shared e-mail database DB2 based on the e-mail thread ID included in the display request received from the groupware system 1. The e-mail thread data transmission module 207 refers to the shared e-mail database DB2 to acquire the subject of each of the shared e-mails belonging to the acquired e-mail thread, at least a part of the body text of each shared e-mail, a name of the attached file of each shared e-mail, or other information. The e-mail thread data transmission module 207 generates e-mail thread data indicating those pieces of information, and transmits the e-mail thread data to the groupware system 1.

The shared e-mail system 2 in Modification Example 2-8 receives, from the groupware system 1, a request for e-mail thread data indicating an e-mail thread of shared e-mails to be registered in the project management app. When the shared e-mail system 2 receives the request, the shared e-mail system 2 transmits the e-mail thread data to the groupware system 1. The e-mail thread is displayed on the project management screen SC6, and hence the user can easily manage the project. When the user selects an e-mail thread, the shared e-mail screen SC2 that shows the shared e-mail belonging to the e-mail thread is displayed on the user terminal 30, and hence the convenience of the user is increased. The user can view the shared e-mail screen SC2 of the groupware from the project management screen SC6 of the groupware without transitioning to another domain.

### Modification Example 2-9

For example, the shared e-mail system 2 may generate, in Modification Example 1-8, partial data for the shared e-mail portion P22 that allows the user to register the e-mail thread in the project management app from the shared e-mail screen SC2. The partial data acquisition module 202 in Modification Example 2-9 acquires the partial data indicating the shared e-mail portion P22 that allows the user to select an e-mail thread from the shared e-mail portion P22 of the shared e-mail screen. For example, the partial data acquisition module 202 acquires the partial data indicating the shared e-mail portion P22 including an e-mail thread selection image for the user to select the e-mail thread.

For example, the partial data acquisition module 202 generates partial data indicating the shared e-mail portion P22 including the button B228. It is assumed that a link for the button B228 includes the domain of the groupware. Thus, when the user selects button B228, the user terminal 30 requests the groupware server 10 to register the e-mail thread in the project management app. Note that the e-mail thread selection image is not limited to the button B228, and may be another image such as an icon. In addition to the e-mail thread selection image, the partial data acquisition module 202 may also use an illustration that can be displayed through use of CSS, text including the link, or another user interface part, to thereby acquire the partial data indicating the shared e-mail portion P22 that allows the user to select the e-mail thread described above.

The shared e-mail system 2 in Modification Example 2-9 acquires the partial data indicating the shared e-mail portion P22 that allows the user to select an e-mail thread from the shared e-mail portion P22 of the shared e-mail screen SC2. The user can view the shared e-mail on the shared e-mail screen SC2 and directly register the e-mail thread of the shared e-mail in the project management app, and hence the convenience of the user is increased.

### Modification Example 2-10

For example, the shared e-mail system 2 may be able to cooperate with a plurality of groupware systems 1. In Modification Example 2-10, each of the plurality of groupware systems 1 displays the shared e-mail portion P22 on the shared e-mail screen SC2 of the groupware managed by the user himself or herself. A request transmitted to the shared e-mail system 2 by each of the plurality of groupware systems 1 may be the same as that in the at least one embodiment. The shared e-mail system 2 receives the same request as that in the at least one embodiment from each of the plurality of groupware systems 1.

The partial data acquisition module 202 in Modification Example 2-10 acquires partial data corresponding to a groupware system 1 that has transmitted the request for the partial data among the plurality of groupware systems 1. The partial data corresponding to the groupware system 1 refers to partial data including a link corresponding to the groupware system 1 or partial data indicating the shared e-mail portion P22 having a layout corresponding to the groupware system 1. The partial data transmission module 203 transmits the partial data corresponding to the groupware system 1 to the groupware system 1 that has transmitted the request for the partial data.

For example, the partial data acquisition module 202 generates partial data indicating a link including the domain of the groupware system 1 that has transmitted the request for the partial data among the plurality of groupware systems 1 and e-mail identification information. It is assumed that the domain of each of the plurality of groupware systems 1 is stored in the data storage unit 200 in advance. The partial data acquisition module 202 may generate partial data having a background color that is the theme color of the groupware system 1 that has transmitted the request for partial data among the plurality of groupware systems 1. It is assumed that the theme color of each of the plurality of groupware systems 1 is stored in advance in the data storage unit 200.

The shared e-mail system 2 in Modification Example 2-10 can cooperate with the plurality of groupware systems 1. The shared e-mail system 2 acquires partial data corresponding to the groupware system 1 that has transmitted the request among the plurality of groupware systems 1. The shared e-mail system 2 cooperates with the plurality of groupware systems 1, thereby being able to increase the convenience of the user.

### 6-3. Other Modification Examples

For example, the above-mentioned modification examples may be combined.

For example, some of the functions described as being implemented by the groupware server 10 may be implemented by the user terminal 30. In this case, the same functions as those of the groupware server 10 may be implemented by being executed by a browser script, or by being executed by a program installed on the user terminal 30. The functions described as being implemented by the groupware server 10 may be shared among a plurality of computers.

For example, some of the functions described as being implemented by the shared e-mail server 20 may be implemented by the user terminal 30. In this case, the same functions as those of the shared e-mail server 20 may be implemented by being executed by a browser script, or by being executed by a program installed on the user terminal 30. The functions described as being implemented by the shared e-mail server 20 may be shared among a plurality of computers.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A groupware system, comprising at least one processor configured to:
request a shared e-mail system, which manages shared e-mails, for partial data indicating a shared e-mail portion, which is a portion for the shared e-mails on a shared e-mail screen of groupware;
acquire the partial data from the shared e-mail system; and
display the shared e-mail screen including a groupware portion, which is a portion for the groupware, and the shared e-mail portion on a user terminal based on the partial data.

2. The groupware system according to claim 1,
wherein a link to each of the shared e-mails displayed in the shared e-mail portion includes a domain of the groupware and shared e-mail identification information on the each of shared e-mails,
wherein the at least one processor is configured to receive, when the link is selected on the user terminal, a display request for the shared e-mail screen from the user terminal, and
wherein processing of the at least one processor is executed each time the at least one processor receives the display request.

3. The groupware system according to claim 1,
wherein the at least one processor is configured to add a plug-in for the shared e-mails for the groupware when a user who uses the groupware performs a predetermined plug-in addition operation, and
wherein processing of the at least one processor is executed based on the plug-in.

4. The groupware system according to claim 1,
wherein the at least one processor is configured to receive designation of an HTML tag indicating the shared e-mails performed by a user who uses the groupware, and
wherein processing of the at least one processor is executed on condition that the HTML tag has been designated.

5. The groupware system according to claim 1, wherein the at least one processor is configured to display, on the user terminal, the shared e-mail screen including the groupware portion from which the groupware is identifiable to a user who uses the groupware and the shared e-mail portion from which the shared e-mail system is unidentifiable to the user.

6. The groupware system according to claim 1, wherein the at least one processor is configured to:
request the shared e-mail system to acquire the shared e-mails based on an e-mail address registered in a customer management app, which manages customer information on a user who uses the groupware;
acquire acquisition result data indicating acquisition results of the shared e-mails from the shared e-mail system; and
display a customer management screen including the customer information and the acquisition results indicated by the acquisition result data on the user terminal based on the customer management app.

7. The groupware system according to claim 1, wherein the at least one processor is configured to register, when a predetermined registration operation is performed on the shared e-mail screen, new customer information in a customer management app, which manages customer information on a user who uses the groupware, based on each of the shared e-mails displayed in the shared e-mail portion.

8. The groupware system according to claim 1, wherein the at least one processor is configured to display a customer management screen of a customer management app, which manages customer information on a user who uses the groupware, on the user terminal based on each of the shared e-mails displayed in the shared e-mail portion when a predetermined display operation is performed on the shared e-mail screen.

9. The groupware system according to claim 1,
wherein the at least one processor is configured to:
register an e-mail thread of the shared e-mails in a project management app, which manages projects of a user who uses the groupware; and
display a project management screen including the e-mail thread on the user terminal based on the project management app, and
wherein processing of the at least one processor is executed when the e-mail thread is selected on the project management screen.

10. The groupware system according to claim 9, wherein the at least one processor is configured to register the e-mail thread of each of the shared e-mails selected from the shared e-mail portion of the shared e-mail screen in the project management app.

11. The groupware system according to claim 9, wherein the at least one processor is configured to register the e-mail thread of each of the shared e-mails designated on the project management screen in the project management app.

12. The groupware system according to claim 1, wherein the at least one processor is configured to register pieces of information included in each of the shared e-mails in an app based on associations between fields of the app, which are set for each app in the groupware, and items included in the each of the shared e-mails.

13. A display control method, comprising:
requesting a shared e-mail system, which manages shared e-mails, for partial data indicating a shared e-mail portion, which is a portion for the shared e-mails on a shared e-mail screen of groupware;
acquiring the partial data from the shared e-mail system; and
displaying the shared e-mail screen including a groupware portion, which is a portion for the groupware, and the shared e-mail portion on a user terminal based on the partial data.

14. A non-transitory information storage medium having stored thereon a program for causing a computer to:
request a shared e-mail system, which manages shared e-mails, for partial data indicating a shared e-mail portion, which is a portion for the shared e-mails on a shared e-mail screen of groupware;
acquire the partial data from the shared e-mail system; and
display the shared e-mail screen including a groupware portion, which is a portion for the groupware, and the shared e-mail portion on a user terminal based on the partial data.
